(19) United States
(12) Patent Application Publication
(10) Pub. No.: US 2026/0369299 A1
(43) Pub. Date: Nov. 19, 2026

(54) MAGNETIC DISK DEVICE AND WRITE PROCESSING METHOD

(71) Applicants: Kabushiki Kaisha Toshiba, Kawasaki-shi (JP); Toshiba Electronic Devices & Storage Corporation, Kawasaki-shi (JP)

(72) Inventors: Shinichirou Kouhara, Hino Tokyo (JP); Yusuke Tomoda, Yokohama Kanagawa (JP); Takao Abe, Yokohama Kanagawa (JP)

(21) Appl. No.: 19/547,427

(22) Filed: Feb. 23, 2026

(30) Foreign Application Priority Data
May 16, 2025 (JP) 2025-082629

(51) Int. Cl. G11B 5/596; G11B 5/012

(52) U.S. Cl. CPC G11B 5/59627; G11B 5/012

(57) ABSTRACT

According to one embodiment, a magnetic disk device includes a disk, a head, a read processing unit, a write processing unit, and a determination unit. The determination unit determines whether a write head has crossed each of a fixed reference line and a fixed additional line in a second direction, controls write processing for a first data track based on information indicating whether the write head has crossed the fixed reference line in the second direction, and controls write processing for a second data track based on information indicating whether the write head has crossed the fixed additional line in the second direction during a first write period.

### CROSS-REFERENCE TO RELATED APPLICATIONS

This application is based upon and claims the benefit of priority from Japanese Patent Application No. 2025-082629, filed May 16, 2025, the entire contents of which are incorporated herein by reference.

### FIELD

Embodiments described herein relate generally to a magnetic disk device and a write processing method.

### BACKGROUND

Magnetic disk devices such as Conventional Magnetic Recording (CMR) (or conventional recording) magnetic disk devices that write data to a plurality of tracks at intervals in the radial direction of the disk, Shingled Magnetic Recording (SMR) magnetic disk devices that overwrite data to a plurality of tracks in the radial direction of the disk, and hybrid recording type magnetic disk devices that selectively perform the conventional magnetic recording and the shingled magnetic recording, are known.

### BRIEF DESCRIPTION OF THE DRAWINGS

FIG. 1 is a block diagram showing a configuration of a magnetic disk device according to an embodiment.

FIG. 2 is a perspective view showing parts of the magnetic disk device, illustrating a plurality of disks and a plurality of heads.

FIG. 3 is a schematic diagram showing an example of arrangement of a plurality of servo areas and a plurality of data areas on a single disk according to the embodiment.

FIG. 4 is a schematic diagram showing three tracks where shingled magnetic recording of a user data area of the disk shown in FIG. 3 is performed, and a write head.

FIG. 5 is a schematic diagram showing three tracks where conventional magnetic recording of the disk shown in FIG. 3 is performed, and a write head.

FIG. 6 is a schematic diagram showing an example of data write processing on the disk.

FIG. 7 is a schematic diagram showing two bands and one guard band of the user data area shown in FIG. 6.

FIG. 8 is a schematic diagram showing three sectors of one track of the band shown in FIG. 6.

FIG. 9 is a schematic diagram showing two bands and one guard band shown in FIG. 7, illustrating a plurality of target sectors and a plurality of unused sectors.

FIG. 10 is a schematic diagram showing an example of the first track and the second track in a case where it is assumed that the above-described magnetic disk device does not comprise a function of executing track-based error correction for track data, illustrating the write processing for the first track and the second track, illustrating a state in which the write processing for the second track is continued until the sector-based error correction for the first track reaches its limit, and illustrating each of the change in BER for the first track and the change in BER for the positioning error in graph form.

FIG. 11 is a schematic diagram showing an example of the first track and second track in a case where it is assumed that the magnetic disk device does not comprise a function of executing track-based error correction for the track data, illustrating the write processing for the first track and the second track, illustrating a state in which a discrimination value is set to a write off-track slice smaller (more severe) than the track margin and the write processing for the second track is ended when a position of a write head crosses a fixed reference line, and illustrating each of the change in BER for the first track and the change in BER for the positioning error in graph form.

FIG. 12 is a schematic diagram showing an example of the first track and second track of the magnetic disk device that comprises a function of executing track-based error correction for the track data, illustrating the write processing for the first track and the second track, illustrating a state in which a discrimination value is set to a write off-track slice greater (more loose) than the track margin and the write processing for the second track is continued until track-based error correction for the first track reaches a limit, and illustrating each of the change in BER for the first track and the change in BER for the positioning error in graph form.

FIG. 13 is a table showing settings related to the presence or absence of track ECC during the first and second write operations, a name of the function controlling DOL, and the processing performed when the write head crosses the fixed reference line.

FIG. 14 is a diagram showing the change in positioning error when the magnetic disk device performs the write processing on the first track in the first write operation, and showing a state in which the positioning error is not compared to a fixed additional line.

FIG. 15 is a diagram showing the change in positioning error when the magnetic disk device performs the write processing on the second track during the first write operation, and showing a state in which a variable reference line is set to a first base line, following FIG. 14.

FIG. 16 is a diagram showing the change in positioning error when the magnetic disk device performs the write processing on the first track in the first write operation, and showing a state in which the positioning error is compared to the fixed additional line.

FIG. 17 is a diagram showing a state in which the variable reference line is set to the first base line and a second base line when the magnetic disk device performs the write processing on the second track in the first write operation, following FIG. 16.

FIG. 18 is a diagram showing the change in positioning error when the magnetic disk device performs the write operation on the second track during the first write operation in a state in which the variable reference line is updated to a strict line, and showing a state in which the write processing on the second track is suspended during the processing, following FIG. 17.

FIG. 19 is a diagram showing a state in which the magnetic disk device resumes the write processing on the second track in the first write operation during the processing, following FIG. 18.

FIG. 20 is a diagram showing the change in positioning error when the magnetic disk device performs the write processing on the first track during the second write operation, and showing a state in which the positioning error is compared to the fixed additional line.

FIG. 21 is a diagram showing a state in which the variable reference line is set to the first base line and a second base line when the magnetic disk device performs the write processing on the second track in the second write operation, following FIG. 20.

FIG. 22 is a diagram showing the change in positioning error when the magnetic disk device performs the write processing on the second track during the second write operation in a state in which the variable reference line is updated to the strict line, following FIG. 21.

### DETAILED DESCRIPTION

In general, according to one embodiment, there is provided a magnetic disk device comprising: a disk having a first data track and a second data track adjacent to each other in a recording layer, the first data track and the second data track each including a plurality of target sectors being targets to which data is written, the first data track being located in a first direction parallel to a radial direction of the disk as viewed from the second data track; a head including a write head writing data to the recording layer and a read head reading data from the recording layer; a read processing unit capable of deriving position information of the write head in the radial direction by seeking the read head; a write processing unit capable of performing write processing of writing data to the recording layer, the write processing unit setting a target position of the write head in the radial direction to a first write target line extending in a circumferential direction of the disk during a first write period for writing data to the first data track, and setting the target position of the write head in the radial direction to a second write target line extending in the circumferential direction during a second write period for writing data to the second data track; and a determination unit performing a following process during the first write period: determining whether the write head has crossed each of the fixed reference line and the fixed additional line in a second direction opposite to the first direction; controlling the write processing for the first data track based on information indicating whether the write head has crossed the fixed reference line in the second direction; and controlling the write processing for the second data track based on information indicating whether the write head has crossed the fixed additional line in the second direction.

According to another embodiment, there is provided a write processing method which is applied to a magnetic disk device including: a head including a disk having a first data track and a second data track adjacent to each other in a recording layer, the first data track and the second data track each including a plurality of target sectors being targets to which data is written, the first data track being located in a first direction parallel to a radial direction of the disk as viewed from the second data track, a write head writing data to the recording layer, and a read head reading data from the recording layer; a read processing unit capable of deriving position information of the write head in the radial direction by seeking the read head; and a write processing unit capable of performing write processing of writing data to the recording layer, the write processing unit setting a target position of the write head in the radial direction to a first write target line extending in a circumferential direction of the disk during a first write period for writing data to the first data track, and setting the target position of the write head in the radial direction to a second write target line extending in the circumferential direction during a second write period for writing data to the second data track, the method comprising: determining whether the write head has crossed each of a fixed reference line and a fixed additional line in a second direction opposite to the first direction, during the first write period; controlling the write processing for the first data track, based on information indicating whether the write head has crossed the fixed reference line in the second direction; and controlling the write processing for the second data track, based on information indicating whether the write head has crossed the fixed additional line in the second direction. The write processing method comprises determining whether the write head has crossed each of the fixed reference line and the fixed additional line in a second direction opposite to the first direction, during the first write period, controlling the write processing for the first data track based on information indicating whether the write head has crossed the fixed reference line in the second direction, during the first write period, and controlling the write processing for the second data track based on information indicating whether the write head has crossed the fixed additional line in the second direction, during the first write period.

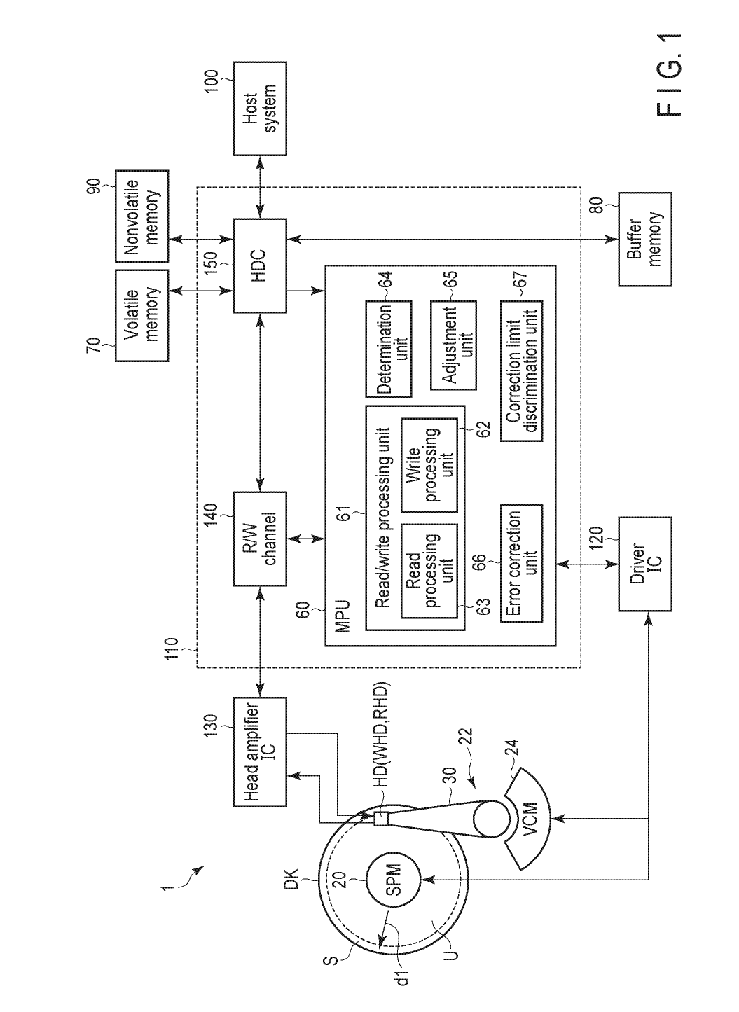

A magnetic disk device 1 according to an embodiment and a write processing method applied to the magnetic disk device 1 will be described hereinafter with reference to the accompanying drawings. First, a configuration of the magnetic disk device 1 will be described. FIG. 1 is a block diagram showing a configuration of the magnetic disk device according to the present embodiment. In the present embodiment, the magnetic disk device 1 is a hybrid recording magnetic disk device that selectively performs the conventional magnetic recording and the shingled magnetic recording. However, a technique to be described below may be applied to a magnetic disk device of the shingled magnetic recording or a magnetic disk device of the conventional magnetic recording.

As shown in FIG. 1, the magnetic disk device 1 comprises a plurality of, for example, one to ten disks (magnetic disks) DK serving as recording media, a spindle motor (SPM) 20 serving as a drive motor, a head stack assembly 22, a driver IC 120, a head amplifier integrated circuit (hereinafter referred to as a head amplifier IC or preamplifier) 130, a volatile memory 70, a buffer memory (buffer) 80, a nonvolatile memory 90, and a system controller 110 that is a single-chip integrated circuit. In addition, the magnetic disk device 1 is connected to a host system (hereinafter simply referred to as a host) 100.

Each disk DK is formed to have a diameter of, for example, 96 mm (3.5 inches) and has recording layers (magnetic recording layers) on both sides. Incidentally, in the present embodiment, the magnetic disk device 1 comprises one to eleven disks DK. However, the number of disks DK is not limited to these.

The head stack assembly 22 can control a head HD mounted on an arm 30 to move. i.e., seek to a target position on the disk DK by driving a voice coil motor (hereinafter referred to as VCM) 24.

A user data area U that can be used for the user, and a system area S where information necessary for the system management is written are assigned to the area of the disk DK where the data can be written.

The head HD records and reproduces information of the disk DK. The head HD comprises a slider as a main body, and comprises a write head WHD and a read head RHD that are mounted on the slider. The write head WHD writes the data to the recording layer of the disk DK. The read head RHD reads the data from data tracks of the recording layer of the disk DK.

The “central part of the head WHD” may be referred to as the “head HD”, the “central part of the write head WHD” may be referred to as the “write head WHD”, and the “central part of the read head RHD” may be referred to as the “read head RHD”. The “central part of the write head WHD” may be referred to simply as the “head HD”, and the “central part of the read head RHD” may be referred to simply as the “head HD”.

The driver IC 120 controls driving the SPM 20 and the VCM 24 under control of the system controller 110 (more specifically, MPU 60 to be described later). The SPM 20 supports and rotates a plurality of disks DK.

The head amplifier IC 130 comprises a read amplifier and a write driver. The read amplifier amplifies a read signal read from the disk DK and outputs the amplified read signal to the system controller 110 (more specifically, a read/write (R/W) channel 140 to be described later). The write driver outputs a write current corresponding to a signal output from the R/W channel 140 to the head HD.

The volatile memory 70 is a semiconductor memory where the stored data is lost when power supply is cut off. The volatile memory 70 stores data and the like necessary for processing in each of units of the magnetic disk device 1. The volatile memory 70 is a random access memory (RAM). The volatile memory 70 is, for example, a dynamic random access memory (DRAM). However, the volatile memory 70 may be a synchronous dynamic random access memory (SDRAM).

The buffer memory 80 is a semiconductor memory which temporarily records data and the like transmitted and received between the magnetic disk device 1 and the host 100. Incidentally, the buffer memory 80 may be formed integrally with the volatile memory 70. The buffer memory 80 is a volatile RAM. Examples of the buffer memory 80 are a DRAM, a static random access memory (SRAM), an SDRAM, a ferroelectric random access memory (FeRAM), a magnetoresistive random access memory (MRAM), and the like.

The buffer memory 80 includes areas used as a read cache and a write cache, and temporarily stores commands and the like, which are received from the host 100.

The nonvolatile memory 90 is a semiconductor memory which records data stored even when power supply is cut off. The nonvolatile memory 90 is, for example, a NAND flash read only memory (FROM). However, the nonvolatile memory 90 may also be a NOR FROM.

The system controller (controller) 110 is realized by using, for example, a large scale integrated circuit (LSI) referred to as a system-on-a-chip (SoC) in which a plurality of elements are integrated on a single chip. The system controller 110 includes a read/write (R/W) channel 140, a hard disk controller (HDC) 150, and a microprocessor (MPU) 60. The system controller 110 is electrically connected to the driver IC 120, the head amplifier IC 130, the volatile memory 70, the buffer memory 80, the nonvolatile memory 90, and the host 100.

The R/W channel 140 executes signal processing of read data transferred from the disk DK to the host 100 and write data transferred from the host 100 in accordance with instructions from the MPU 60 to be described later. The R/W channel 140 comprises a circuit or function of modulating the write data. In addition, the R/W channel 140 comprises a circuit or a function of measuring the signal quality of the read data. The R/W channel 140 is electrically connected to, for example, the head amplifier IC 130, the HDC 150, the MPU 60 and the like.

The HDC 150 controls data transfer between the host 100 and the R/W channel 140 in accordance with instructions from the MPU 60. The HDC 150 is electrically connected to, for example, the R/W channel 140, the MPU 60, the volatile memory 70, the buffer memory 80, the nonvolatile memory 90, and the like.

The HDC 150 includes a gate generation unit. In accordance with the commands from the host 100, instructions from the MPU 60, and the like, the gate generation unit generates various gates, for example, a write gate, a read gate, a servo gate, and the like and outputs the gates to the R/W channel 140, for example, the gate detection unit. In the following descriptions, “activating a predetermined gate” may be referred to as “asserting a predetermined gate”. In addition, “falling down a predetermined gate” may be referred to as “negating a predetermined gate”. In addition, “asserting a predetermined gate” and “negating a predetermined gate” may imply the meaning “generating a predetermined gate”. Incidentally, the gate generation unit may be included in the R/W channel 140 or the MPU 60.

The R/W channel 140 includes a gate detection unit. The gate detection unit detects whether various gates, for example, the write gate, the read gate, the servo gate, and the like are in an asserted state or a negated state.

For example, the gate detection unit executes the write processing when detecting that the write gate is asserted, and suspends (stops) the write processing when detecting that the write gate is negated.

In addition, the gate detection unit executes the read processing when detecting that the read gate is asserted, and stops the read processing when detecting that the read gate is negated. The gate detection unit executes the servo read processing when detecting that the servo gate is asserted, and stops the servo read processing when detecting that the servo gate is negated. Incidentally, the gate detection unit may be provided inside the HDC 150 or the MPU 60.

The MPU 60 is a control unit or main controller which controls each of units of the magnetic disk device 1. The MPU 60 controls the VCM 24 via the driver IC 120 to execute servo control for positioning the head HD. The MPU 60 controls the operation of writing the data to the disk DK and selects a storage destination of the write data transferred from the host 100. In addition, the MPU 60 controls the operation of reading the data from the disk DK and controls the processing of the read data transferred from the disk DK to the host 100. The MPU 60 is connected to each unit of the magnetic disk device 1. The MPU 60 is electrically connected to, for example, the driver IC 120, the R/W channel 140, the HDC 150 and the like.

The MPU 60 comprises a read/write processing unit 61, a determination unit 64, an adjustment unit 65, an error correction unit 66, a correction limit discrimination unit 67, and the like. The MPU 60 performs on firmware the processing of the units, for example, the read/write processing unit 61, the determination unit 64, the adjustment unit 65, the error correction unit 66, the correction limit discrimination unit 67, and the like. Incidentally, the MPU 60 may comprise each of these units as a circuit.

The read/write processing unit 61 includes a write processing unit 62 and a read processing unit 63. In accordance with commands from the host 100, the write processing unit 62 controls the data write processing, and the read processing unit 63 controls the data read processing to cause the read head RHD to read the data from the disk DK. The read processing unit 63 can seek the read head RHD to derive position information of the write head WHD in a radial direction d1 of the disk DK. The write processing unit 62 can perform the write processing of writing the data to the recording layer of the disk DK. The read/write processing unit 61 controls the VCM 24 via the driver IC 120, positions the head HD at a target position (predetermined radial position) on the disk DK, and performs the read processing or the write processing.

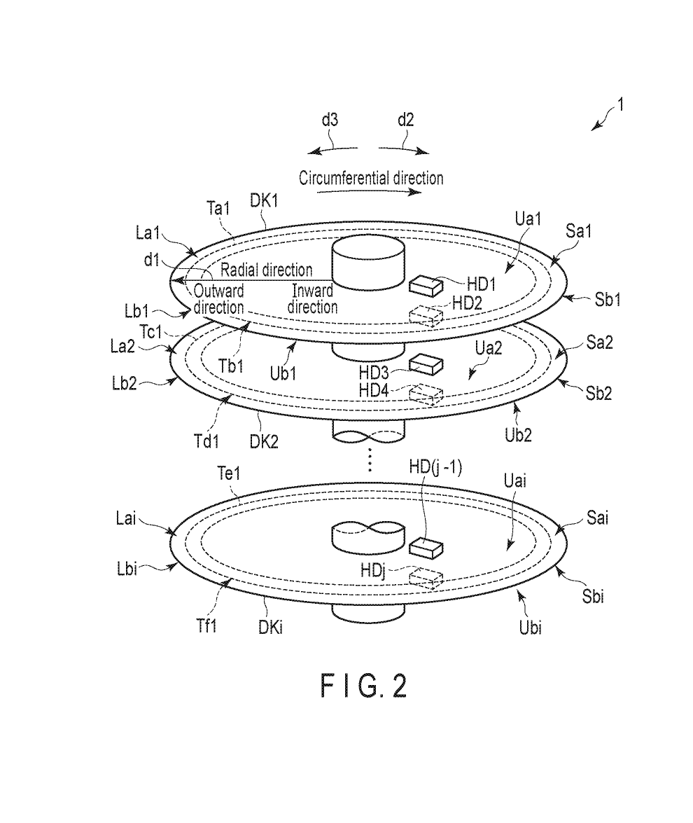

FIG. 2 is a perspective view showing parts of the magnetic disk device 1, illustrating a plurality of disks DK and a plurality of heads HD.

As shown in FIG. 2, the rotation of direction of the disks DK in the circumferential direction is referred to as a rotational direction d3. Incidentally, in the example shown in FIG. 2, the rotational direction d3 is illustrated as a counterclockwise direction, but may be an opposite (clockwise) direction. In addition, a traveling direction d2 of the heads HD relative to the disks DK is opposite to the rotational direction d3. The traveling direction d2 is the direction in which the heads HD sequentially write the data to and read data from the disks DK in the circumferential direction, i.e., the direction in which the heads HD travel with respect to the disks DK in the circumferential direction.

The magnetic disk device 1 comprises i disks, from disk DK1 through disk DKi, and j heads, from head HD1 through head HDj. In the present embodiment, the number of heads HD is twice the number of disks DK (j = 2 x i).

The disks DK1 through DKi are provided coaxially to be spaced apart from each other at intervals and overlap with each other. The diameters of the disks DK1 to DKi are the same as each other. The terms “same”, “identical”, “matching”, “equivalent” and the like imply not only the meaning of being exactly the same, but also the meaning of being different to the extent that they can be regarded as substantially the same. Incidentally, the diameters of the disks DK1 to DKi may be different from each other.

Each of the disks DK has recording layers L on both sides. For example, the disk DK1 has a first recording layer La1 and a second recording layer Lb1 on the side opposite to the first recording layer La1. The disk DK2 has a first recording layer La2 and a second recording layer Lb2 on the side opposite to the first recording layer La2. The disk DKi has a first recording layer Lai and a second recording layer Lbi on the side opposite to the first recording layer Lai. Each first recording layer La may be referred to as a surface or a recording surface. Each second recording layer Lb may be referred to as a back surface or a recording surface.

However, each first recording layer La may be referred to as a back surface. In this case, each second recording layer Lb may be referred to as a surface.

Each of the recording layers L includes a user data area U and a system area S. The first recording layer La1 includes a user data area Ua1 and a system area Sa1. The second recording layer Lb1 includes a user data area Ub1 and a system area Sb1. The first recording layer La2 includes a user data area Ua2 and a system area Sa2. The second recording layer Lb2 includes a user data area Ub2 and a system area Sb2. The first recording layer Lai includes a user data area Uai and a system area Sai. The second recording layer Lbi includes a user data area Ubi and a system area Sbi.

A track sandwiched between double broken lines in the figure, of the user data area Ua1 (first recording layer La1), is referred to as track Ta1. A track located on a side opposite to the track Ta1, of the user data area Ub1 (second recording layer Lb1), is referred to as track Tb1.

A track sandwiched between double broken lines in the figure, of the user data area Ua2 (first recording layer La2), is referred to as track Tc1. A track located on a side opposite to the track Tc1, of the user data area Ub2 (second recording layer Lb2), is referred to as track Td1.

A track sandwiched between double broken lines in the figure, of the user data area Uai (first recording layer Lai), is referred to as track Te1. A track located on a side opposite to the track Te1, of the user data area Ubi (second recording layer Lbi), is referred to as track Tf1.

In the present embodiment, the tracks Ta1, Tb1, Tc1, Td1, Te1, and Tf1 are located on the same cylinder.

The heads HD face the disks DK. In the present embodiment, one head HD faces each of the recording layers L of the disk DK. For example, the head HD1 faces the first recording layer La1 of the disk DK1, writes the data to the first recording layer La1, and reads the data from the first recording layer La1. The head HD2 faces the second recording layer Lb1 of the disk DK1, writes the data to the second recording layer Lb1, and reads the data from the second recording layer Lb1.

The head HD3 faces the first recording layer La2 of the disk DK2, writes the data to the first recording layer La2, and reads the data from the first recording layer La2. The head HD4 faces the second recording layer Lb2 of the disk DK2, writes the data to the second recording layer Lb2, and reads the data from the second recording layer Lb2. The head HDj-1 faces the first recording layer Lai of the disk DKi, writes the data to the first recording layer Lai, and reads the data from the first recording layer Lai. The head HDj faces the second recording layer Lbi of the disk DKi, writes the data to the second recording layer Lbi, and reads the data from the second recording layer Lbi.

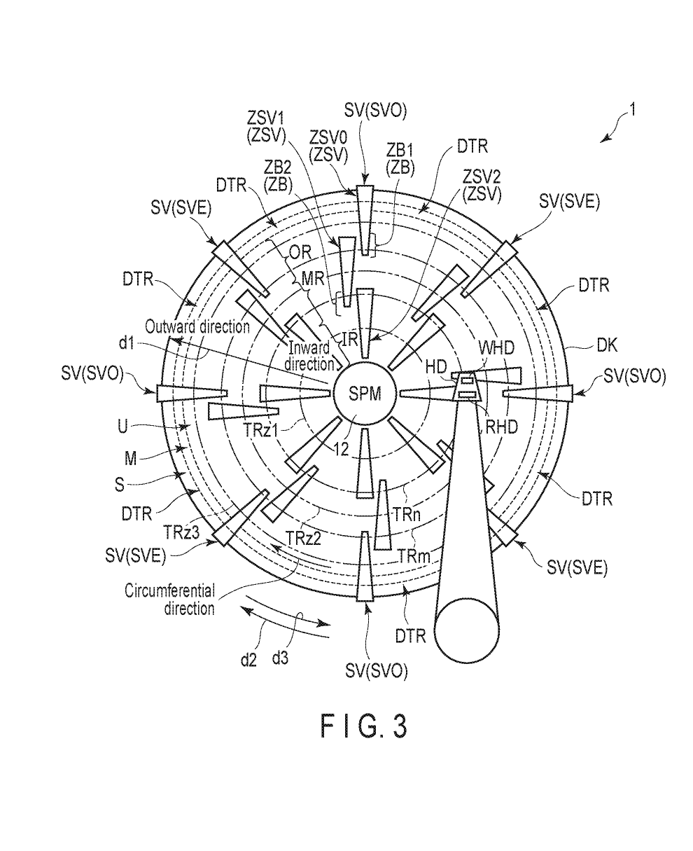

FIG. 3 is a schematic diagram showing an example of arrangement of a plurality of servo areas SV and a plurality of data areas DTR on the single disk DK according to the present embodiment. As shown in FIG. 3, a direction toward the outer circumference of the disk DK in the radial direction d1 of the disk DK is referred to as an outward direction (outside), and a direction opposite to the outward direction is referred to as an inward direction (inside).

In FIG. 3, the user data area U is divided into an inner circumferential area IR located in the inward direction, an outer circumferential area OR located in the outward direction, and an intermediate circumferential area MR located between the inner circumferential area IR and the outer circumferential area OR.

The disk DK includes a plurality of servo areas SV and a plurality of data areas DTR. For example, the plurality of servo areas SV may extend radially in the radial direction of the disk DK and may be discretely arranged at predetermined intervals in the circumferential direction. For example, the plurality of servo areas SV may extend linearly from the inner circumference to the outer circumference and may be discretely arranged at predetermined intervals in the circumferential direction. For example, the plurality of servo areas SV may extend in a spiral shape from the inner circumference to the outer circumference and may be discretely arranged at predetermined intervals in the circumferential direction. Alternatively, for example, the plurality of servo areas SV may be arranged in a form of islands in the radial direction and may be discretely arranged at different predetermined intervals in the circumferential direction.

In the following descriptions, one servo area SV in a predetermined track may also be referred to as a “servo sector”. Incidentally, the “servo area SV” may also be referred to as a “servo sector SV”. The servo sector includes servo data. The “arrangement and the like of several servo data elements constituting the servo sector” may be hereinafter referred to as a “servo pattern”. Incidentally, the “servo data written to the servo sector” may also be referred to as a “servo sector”.

Each of the plurality of data areas DTR is arranged between the plurality of servo areas SV. For example, the data area DTR corresponds to the area between two continuous servo areas SV in the circumferential direction. One data area DTR on a predetermined track may be referred to as a “data sector” in the following descriptions. Incidentally, the “data area DTR” may also be referred to as a “data sector DTR”. The data sector includes user data. Incidentally, the “user data written to the data sector” may also be referred to as the “data sector”. The “data sector” may also be referred to as the “user data”. In addition, “a pattern composed of several data elements” may also be referred to as a “data pattern”. In the example shown in FIG. 3, the data pattern on a predetermined track is composed of a plurality of servo data elements (servo sectors) and a plurality of user data elements (data sectors).

The servo area SV includes a plurality of zone servo areas ZSV and the like. Incidentally, in addition to the zone servo areas ZSV, the servo area SV may include an area including a gap (i.e., displacement of circumferential positions of two zone servo areas), an area including the servo data, the data area DTR, and the like. The plurality of zone servo areas ZSV are discretely arranged in the radial direction d1. Each of the plurality of zone servo areas ZSV extends in the radial direction d1.

One zone servo area (servo area) ZSV in a predetermined track may also be referred to as a “zone servo sector” or a “servo sector”. Incidentally, the “zone servo area (servo area) ZSV” may also be referred to as a “zone servo sector ZSV” or a “servo sector ZSV”. The “servo data written in the zone servo sector” may also be referred to as a “zone servo sector” or a “servo sector”. The “arrangement of several servo data elements constituting the zone servo sector” may also be referred to as a “zone servo pattern” or a “servo pattern”. One servo area SV in a predetermined track may also be hereinafter referred to as a “zone pattern sector”.

Incidentally, the “servo area SV” may also be referred to as the “zone pattern sector”. The “at least one data element and the like written to the zone pattern sector” may also be referred to as the “zone pattern sector”. The zone pattern sector includes at least one zone servo sector. The “data pattern of the zone pattern sector” may also be hereinafter referred to as a “zone data pattern”.

In the example shown in FIG. 3, the servo areas SV include zone servo areas ZSV0, ZSV1, and ZSV2. The zone servo areas ZSV0, ZSV1, and ZSV2 are arranged in a staggered pattern in the radial direction. The zone servo areas ZSV0, ZSV1, and ZSV2 may also be arranged in a staircase pattern in the radial direction.

The zone servo area ZSV2 is located on an inner circumferential side than the zone servo area ZSV1. The zone servo area ZSV0 is located on an outer circumferential side than the zone servo area ZSV1. For example, the zone servo area ZSV2 is arranged from the inner circumferential area IR to the middle circumferential area MR, the zone servo area ZSV1 is arranged from the inner circumferential area IR to the outer circumferential area OR, and the zone servo area ZSV0 is arranged from the middle circumferential area MR to the outer circumferential area OR. In the following descriptions, a predetermined radial area in which the plurality of zone servo areas ZSV are arranged in the circumferential direction, in a predetermined servo area SV, may also be referred to as a zone servo boundary area, a double servo area, or a double zone servo area ZB.

In the example shown in FIG. 3, the main servo areas SVO and the sub-servo areas SVE are alternately arranged at intervals in the circumferential direction. For example, one sub-servo area SVE is arranged between two main servo areas SVO that are continuously aligned at an interval in the circumferential direction. In other words, one sub-servo area SVE is arranged between two main servo areas SVO that are continuously aligned at an interval in the circumferential direction. For example, when sequentially continuous numbers are assigned to all the servo areas SV of the disk DK, the main servo areas SVO correspond to the odd-numbered servo areas SV, and the sub-servo areas SVE correspond to the even-numbered servo areas SV. Incidentally, two or more sub-servo areas SVE may be arranged between two main servo areas SVO that are continuously arranged at an interval, in the circumferential direction.

The main servo areas SVO and the sub-servo areas SVE may be composed of, for example, only servo areas that read and demodulate the servo data as a whole (hereinafter often referred to as normal servo areas). In the following descriptions, “reading and demodulating the servo data” may also be referred to as “servo-reading”. The main servo areas SVO and the sub-servo areas SVE may also be composed of, for example, the normal servo areas, and servo areas (hereinafter often referred to as short servo areas) where servo-reading is performed in a smaller circumferential range of the servo data than a circumferential range of the servo data where servo-reading is performed in the normal servo areas.

A media cache M is allocated to the disk DK. However, the media cache M may not be arranged on the disk DK.

By using the plurality of servo data elements described above, for example, the positioning error of the head HD (for example, the write head WHD) can be derived.

In the present embodiment, the example in which the number of zones of the disk DK is three has been described, but the number of zones of the disk DK can be variously changed. The number of zones of the disk DK may be thirty to forty. In addition, each of the zones includes a plurality of bands. For example, each of the zones includes several hundreds of bands.

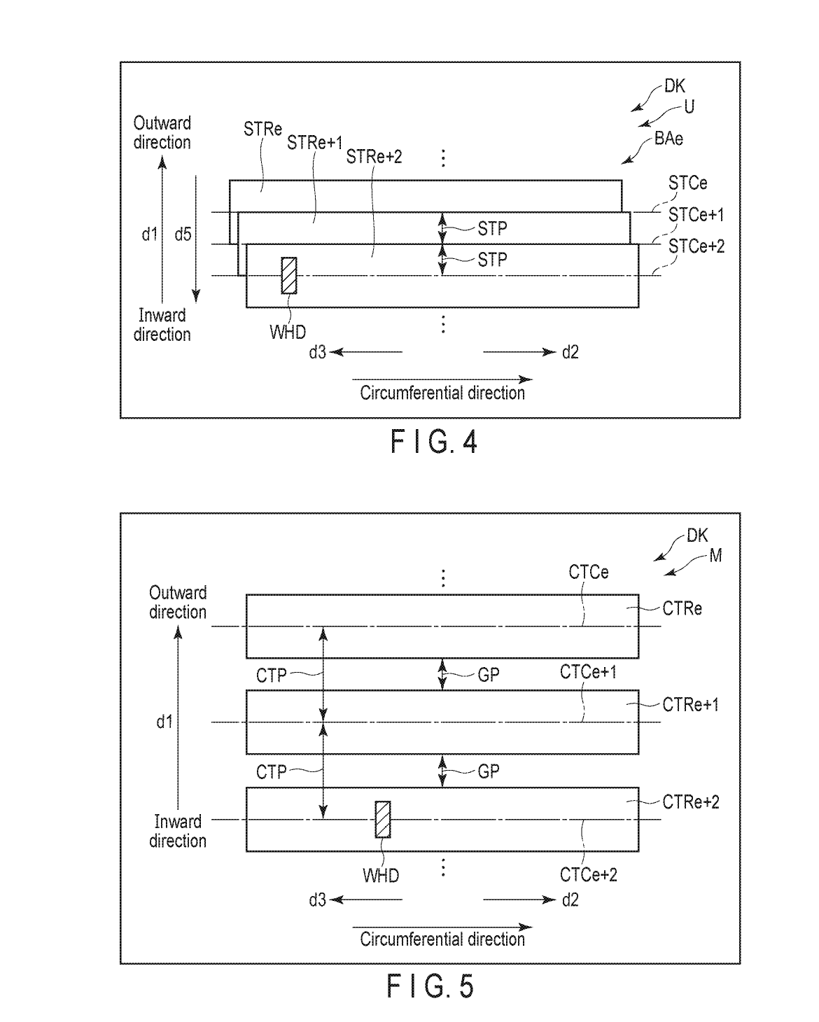

FIG. 4 is a schematic diagram showing three tracks STR of a user data area U where shingled magnetic recording of the disk DK shown in FIG. 3 is executed, and a write head WHD. The user data area U includes a shingled magnetic recording area. Sequentially writing the data in band units within the user data area U is permitted, i.e., shingled magnetic recording is permitted.

As shown in FIG. 4, the write head WHD can sequentially write the data to the disk DK in the traveling direction d2. The read head RHD shown in FIG. 3 can also sequentially read the data written to the disk DK in the traveling direction d2.

In the direction parallel to the radial direction d1, the direction of sequentially executing the shingled magnetic recording for a plurality of tracks STR that are a plurality of data tracks, i.e. the direction of making a track STR to which the data is be next written overlap with a track STR to which the data has been previously written, in the radial direction d1, is referred to as an overwrite direction or a recording progress direction. In a band BAe shown in FIG. 4, an overwrite direction d5 is an inward direction, but the overwrite direction may be an outward direction.

For example, the overwrite direction applied to a plurality of bands BA (a plurality of zones Z) located on an outer circumference side relative to a specific radial position and an overwrite direction applied to a plurality of bands BA (a plurality of zones Z) located on an inner circumferential side relative to the specific radial position may be opposite to each other.

The band BAe includes a plurality of tracks STR including tracks STRe, STRe+1, and STRe+2. The data is continuously overwritten to the tracks STRe, STRe+1, and STRe+2 in the overwrite direction d5 in the order of these tracks. The track STRe among the tracks STRe, STRe+1, and STRe+2 corresponds to the track where data is first written, and the track STRe+2 corresponds to the track where data is last written.

The track STRe has a track center STCe in the center of the radial direction d1 when data is not overwritten to the other track. The track STRe+1 has a track center STCe+1 in the center of the radial direction d1 when data is not overwritten to the other track. The track STRe+2 has a track center STCe+2 in the center of the radial direction d1 when data is not overwritten to the other track.

In the example shown in FIG. 4, the data is written to the tracks STRe, STRe+1, and STRe+2 at a pitch (shingled magnetic recording track pitch) STP. The track center STCe of the track STRe and the track center STCe+1 of the track STRe+1 are separated from each other at the pitch STP in the radial direction d1. The track center STCe+1 of the track STRe+1 and the track center STCe+2 of the track STRe+2 are separated from each other at the pitch STP in the radial direction d1. The data may be written to the tracks STRe to STRe+2 at different pitches.

A width in the radial direction d1 of the area where data is not overwritten to the track STRe+1, of the track STRe, is the same as a width in the radial direction d1 of the area where data is not overwritten to the track STRe+2, of the track STRe+1. Incidentally, the width in the radial direction d1 of the area where data is not overwritten to the track STRe+1, of the track STRe, may be different from the width in the radial direction d1 of the area where data is not overwritten to the track STRe+2, of the track STRe+1.

In FIG. 4, each track STR has a rectangular shape for convenience of descriptions. In reality, however, each track STR is curved along the circumferential direction. In addition, each track STR may have a wave shape extending in the circumferential direction while varying in the radial direction d1. Incidentally, data is overwritten to three tracks STR in FIG. 4, but data may be overwritten to two tracks STR or more than three tracks STR.

The write processing unit 62 can select the shingled magnetic recording of overwriting the data to the plurality of tracks STR in the overwrite direction d5 and cause the write head WHD to write the data to each of the bands BA. In the example shown in FIG. 4, the write processing unit 62 sequentially executes the shingled magnetic recording for the tracks STRe to STRe+2 in the band BAe at the pitch STP in the inward direction (overwrite direction d5). Since the user data area U is the area where the data is written in the shingled magnetic recording, the recording density of the user data area U can be improved.

The write processing unit 62 writes the data to the track STRe+1 at the pitch STP in the inward direction of the track STRe and overwrites data to the track STRe+1 and an inner circumferential part of the track STRe. The write processing unit 62 writes the data to the track STRe+2 at the pitch STP in the inward direction of the track STRe+1 and overwrites data to the track STRe+2 and an inner circumferential part of the track STRe+1.

FIG. 5 is a schematic diagram showing three tracks CTR of a media cache M where conventional magnetic recording of the disk DK shown in FIG. 3 is performed, and a write head WHD. The media cache M and the system area S shown in FIG. 3 are the conventional magnetic recording areas. In the media cache M and the system area S, randomly writing the data is permitted, i.e., conventional magnetic recording is permitted.

As shown in FIG. 5, the media cache M includes a plurality of tracks CTR including tracks CTRe, CTRe+1, and CTRe+2. Each of the plurality of tracks CTR is a data track. For example, widths (track widths) in the radial direction d1 of the tracks CTRe, CTRe+1, and CTRe+2 are the same as each other. Incidentally, the track widths of the tracks CTRe to CTRe+2 may be different from each other.

The track CTRe has a track center CTCe in the center of the radial direction d1, the track CTRe+1 has a track center CTCe+1 in the center of the radial direction d1, and the track CTRe+2 has a track center CTCe+2 in the center of the radial direction d1. In the example shown in FIG. 5, the data is written to the tracks CTRe, CTRe+1, and CTRe+2 at the pitch (conventional magnetic recording track pitch) CTP. The track center CTCe of the track CTRe and the track center CTCe+1 of the track CTRe+1 are separated from each other at the pitch CTP. The track center CTCe+1 of the track CTRe+1 and the track center CTCe+2 of the track CTRe+2 are separated from each other at the pitch CTP.

The track CTRe and the track CTRe+1 are separated from each other at a gap GP. The track CTRe+1 and the track CTRe+2 are separated from each other at the gap GP. Incidentally, the data may be written to the tracks CTRe to CTRe+2 at different pitches. In FIG. 5, each track CTR has a rectangular shape for convenience of descriptions. In reality, however, each track CTR is curved along the circumferential direction. In addition, each track CTR may have a wave shape extending in the circumferential direction while varying in the radial direction d1.

The write processing unit 62 can execute the write processing by selecting the conventional magnetic recording of writing the data to the plurality of tracks CTR spaced apart in the radial direction d1 of the disk DK. In the example shown in FIG. 5, the write processing unit 62 positions the write head WHD to the track center CTCe in a predetermined area of the disk DK and executes the conventional magnetic recording for the track CTRe or a predetermined sector of the track CTRe.

The write processing unit 62 positions the write head WHD to the track center CTCe+1, which is separated from the track center CTCe of the track CTRe in the inner direction at the pitch CTP, and executes the conventional magnetic recording for the track CTRe+1 or a predetermined sector of the track CTRe+1. The write processing unit 62 positions the write head WHD to the track center CTCe+2, which is separated from the track center CTCe+1 of the track CTRe+1 in the inner direction at the pitch CTP, and executes the conventional magnetic recording for the track CTRe+2 or a predetermined sector of the track CTRe+2.

The write processing unit 62 may sequentially execute the conventional magnetic recording for the tracks CTRe, CTRe+1, and CTRe+2, in a predetermined area of the disk DK, or randomly execute the conventional magnetic recording for a predetermined sector of the track CTRe, a predetermined sector of the track CTRe+1, and a predetermined sector of the track CTRe+2.

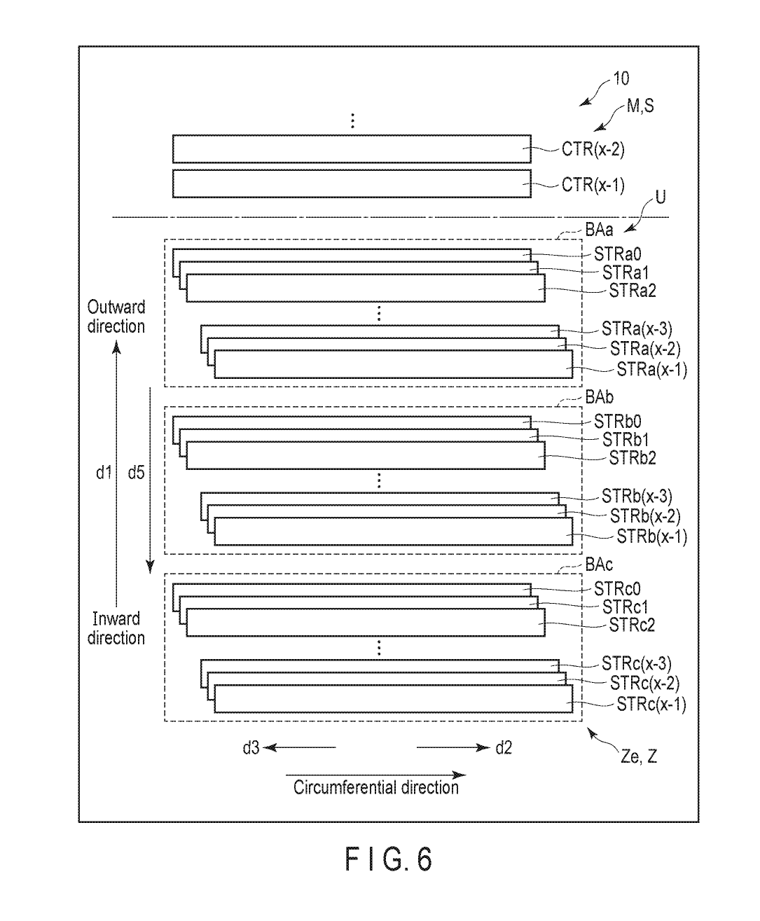

FIG. 6 is a schematic diagram showing an example of the data write processing on the disk DK. Each of the tracks STR and CTR is a data track. As shown in FIG. 6, the user data area U includes bands BAa, BAb, and BAc. The bands BAa, BAb, and BAc belong to the same zone Ze. In the zone Ze, the bands BAa, BAb, and BAc are intermittently arranged in the overwrite direction in the order of these bands.

The bands BAa and BAb are adjacent to each other in the radial direction d1, and the bands BAb and BAc are adjacent to each other in the radial direction d1.

The band BAa includes x tracks such as tracks STRa0, STRa1, STRa2, . . ., STRa(x-3), STRa(x-2), and STRa(x-1). The tracks STRa0 to STRa(x-1) are subjected to the shingled magnetic recording in the overwrite direction d5 in the order of these tracks. In the band BAa, the track STRa0 corresponds to a first track where the data is first written, and the track STRa(x-1) corresponds to the last track where the data is last written.

The band BAb includes x tracks such as tracks STRb0, STRb1, STRb2, . . ., STRb(x-3), STRb(x-2), and STRb(x-1). The tracks STRb0 to STRb(x-1) are subjected to the shingled magnetic recording in the overwrite direction d5 in the order of these tracks. In the band BAb, the track STRb0 corresponds to a first track where the data is first written, and the track STRb(x-1) corresponds to the last track where the data is last written.

The band BAc includes x tracks such as tracks STRc0, STRc1, STRc2, . . ., STRc(x-3), STRc(x-2), and STRc(x-1). The tracks STRc0 to STRc(x-1) are subjected to the shingled magnetic recording in the overwrite direction d5 in the order of these tracks. In the band BAc, the track STRc0 corresponds to a first track where the data is first written, and the track STRc(x-1) corresponds to the last track where the data is last written.

The recording layer L of the disk DK has a plurality of zones Z including zone Ze. The number of the tracks STR included in each of the bands BA belonging to the same zone Z is the same. For example, the number of the tracks STR included in each of the bands BA belonging to the zone Ze is the same. In other words, the number of the tracks STR included in the band BA is fixed for each zone Z. In this example, the number of tracks STR in each of the bands BA belonging to the zone Ze is x.

FIG. 6 shows tracks CTR(x-2) and CTR(x-1). In FIG. 6, the tracks CTR(x-2) and CTR(x-1) are subjected to the conventional magnetic recording in the media cache M or the system area S. The tracks CTR(x-2) and CTR(x-1) are adjacent to each other in the radial direction d1.

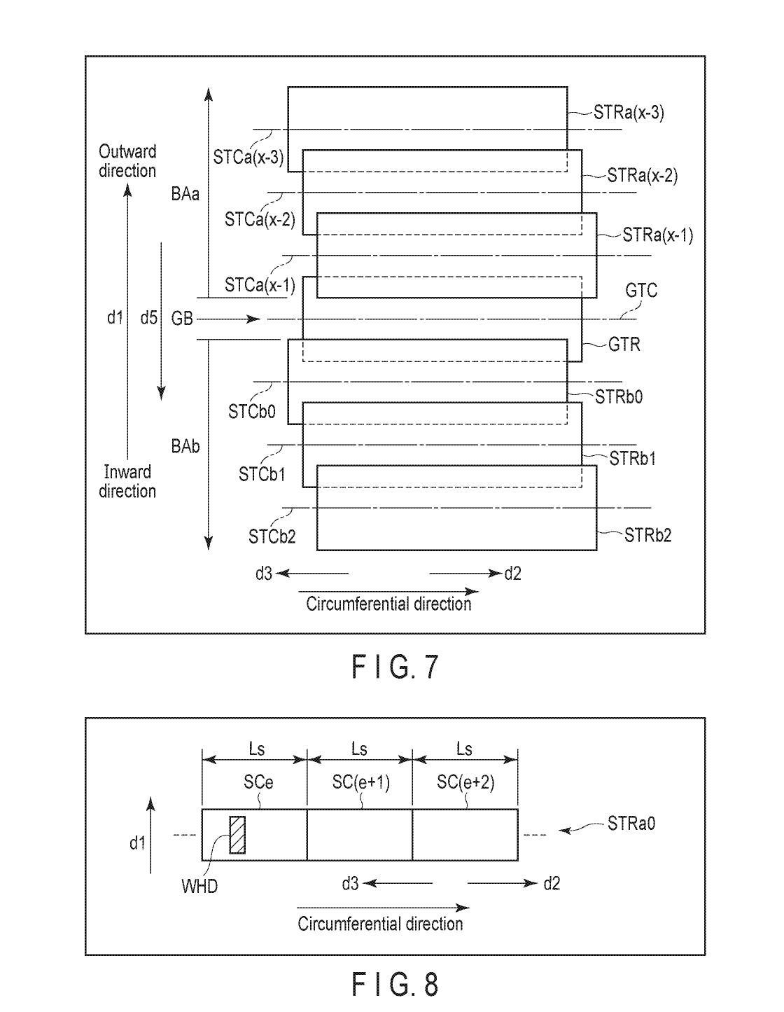

FIG. 7 is a schematic diagram showing two bands BAa and BAb and one guard band GB of the user data area U shown in FIG. 6. As shown in FIG. 7, in the shingled magnetic recording, unlike the conventional magnetic recording, the MPU 60 manages a track group of the user data area U in units referred to as bands, with the feature of overwriting the data to a part of the track STR.

A guard band GB is generally provided between bands BA adjacent in the radial direction d1. The guard band GB includes a guard track GTR. Unlike the present embodiment, the guard band GB may include a plurality of guard tracks GTR. The guard band GB has a role of suppressing the interference between the adjacent bands BA. The shingled magnetic recording can be performed in a unit of one band BA by the guard band GB. In addition, the ranges (bands BA) where the data is sequentially written can be separated by the guard band GB.

For example, the track center STCa(x-3) of the track STRa(x-3), the track center STCa(x-2) of the track STRa(x-2), the track center STCa(x-1) of the track STRa(x-1), the track center GTC of the guard track GTR, the track center STCb0 of the track STRb0, the track center STCb1 of the track STRb1, and the track center STCb2 of the track STRb2, are located at equal pitches in the overwrite direction d5.

The recording capacity of each band BA in the user data area U, except for the guard band GB, is generally predetermined based on the specifications required by the user. The MPU 60 can record the same capacity of data in each of the bands BA. In general, the recording capacity of each band BA is 128 MiB or 256 MiB.

FIG. 8 is a schematic diagram showing three sectors SCe, SC(e+1), and SC(e+2) of one track STRa0 of the band BAa shown in FIG. 6. As shown in FIG. 8, each of the tracks STR includes a plurality of sectors SC. The track STRa1 includes a plurality of sectors SC including sectors SCe, SC(e+1), and SC(e+2).

When the sector SC(e+1) is referred to as an n-th sector among the plurality of sectors SC of the track STRa0, then the sector SC(e+2) is the n+1-th sector following the sector SC(e+1) in the traveling direction d2, and the sector SCe is the n-1-th sector located in front of the sector SC(e+1) in the traveling direction d2. The number of the sectors SC included in each of the tracks STR belonging to the same zone Z is the same. In the present embodiment, the number of sectors SC included in each of the tracks STR belonging to the zone Ze is y.

Each of the sectors SC has a length Ls in the circumferential direction of the disk DK. Each sector SC may be a split sector which is divided by the servo sector SV. In this case, the length of the sector SC does not need to be Ls.

The write head WHD is a magnetic head for energy-assisted recording that performs energy-assisted magnetic recording (EAMR). In the present embodiment, the write head WHD is configured to use energy other than the magnetic energy, but the write head WHD may also be a magnetic head which is not configured to perform the energy-assisted magnetic recording.

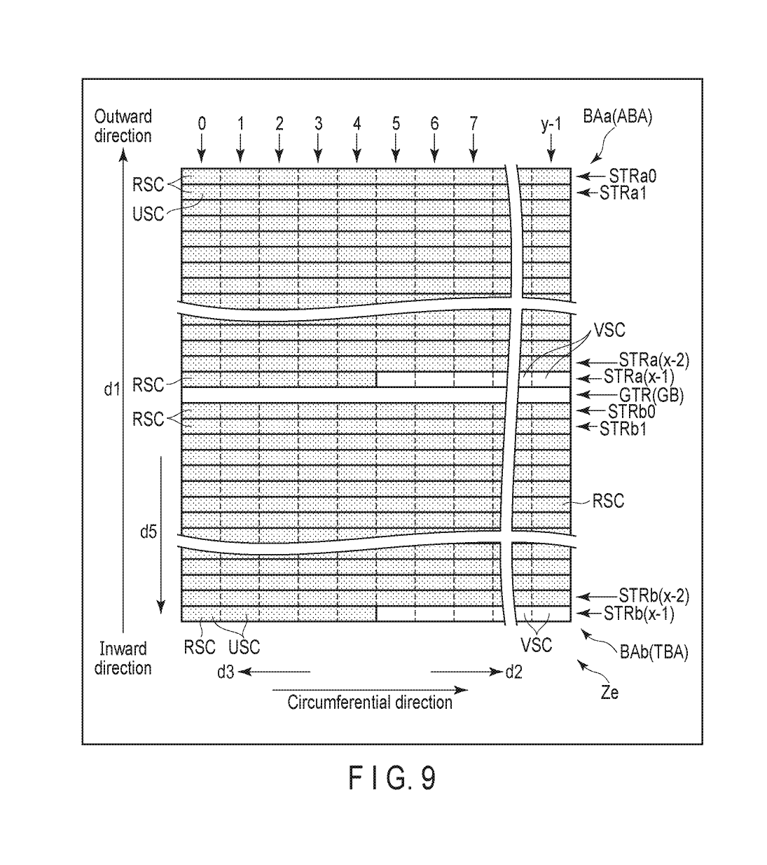

FIG. 9 is a schematic diagram showing the two bands BAa and BAb and one guard band GB shown in FIG. 7, illustrating the plurality of target sectors RSC and the plurality of unused sectors VSC.

In FIG. 9, each of the tracks STR has a rectangular shape for convenience of description. In reality, however, each track STR is curved along the circumferential direction. In addition, a plurality of tracks STR are not made to overlap but are arranged in the overwrite direction d5. In reality, however, the plurality of tracks STR are arranged in the overwrite direction d5 while overlapping. In the figure, the target sector RSC is marked with a dot pattern. The unused sectors VSC are represented by a solid color.

As shown in FIG. 9, the band number of the band BAa is “a” and the band number of the band BAb is “b”. The track number of each band BA is “0” to “x-1”. The sector number of each track STR is “0” to “y-1”. In the following descriptions, the sector SC of each band BA may be recognized by the following code “SC (track number or sector number)”.

In the present embodiment, the band BAa is a band adjacent to the band BAb, and is a band located above the band BAb in the overwrite direction d5.

Each of the tracks STR of the band BAa includes G target sectors RSC (one or more target sectors RSC) to which valid data is written. For example, the track STRa0 includes y target sectors RSC (G = y). All the sectors SC of the track STRa0 are the target sectors RSC. The track STRa(x-1) includes five target sectors RSC (G = 5). The remaining sectors SC of the track STRa(x-1) are unused sectors VSC where valid data is not written.

Based on the above, the number of target sectors RSC in the track STRa0 is different from the number of target sectors RSC in the track STRa(x-1).

In each of the bands BA of the zone Ze, all sectors SC of x-1 tracks STR from number 0 to number x-2 are the target sectors RSC to which valid data is written, and are recording sectors USC. In the x-1-th track STR of each band BA of the zone Ze, five sectors SC from number 0 to number 4 are the target sectors RSC, and are recording sectors USC. In contrast, in the x-1-th track STR, remaining sectors SC from number 5 to number y-1 are the unused sectors VSC where valid data is not written.

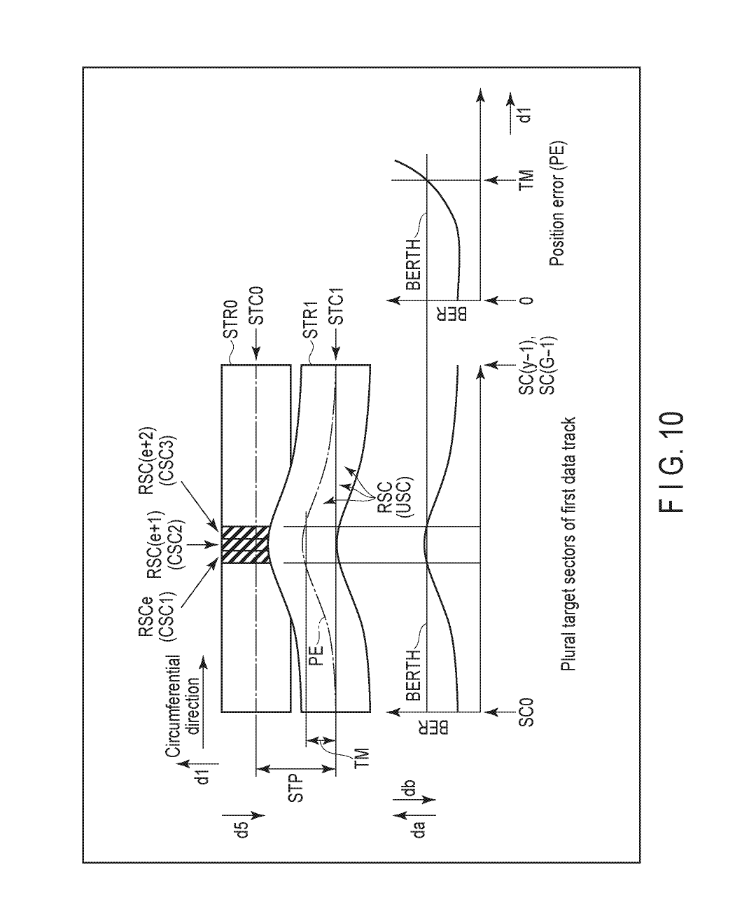

FIG. 10 is a schematic diagram showing an example of the first track STR0 and the second track STR1 in a case where it is assumed that the magnetic disk device 1 does not comprise a function of executing the error correction of the data on the track TR, illustrating the write processing for the first track STR0 and the second track STR1, illustrating a state in which the write processing for the second track STR1 is continued until the error correction in each sector for the first track STR0 reaches its limit, and illustrating each of the change in a bit error rate (BER) for the first track STR0 and the change in BER for a positioning error PE in graph form. In the descriptions made with reference to FIG. 10, it is assumed that the magnetic disk device 1 does not comprise the error correction unit 66 shown in FIG. 1. In addition, in FIG. 10 as well, the first track STR0 and the like are drawn by assuming the circumferential direction to be linear, for convenience of descriptions.

As shown in FIG. 10, in the recording layer L, the plurality of tracks STR are adjacent in the radial direction d1. The first track STR0 and the second track STR1 are the data tracks adjacent to each other, and all sectors SC of the first track STR0 and all sectors (data sectors) SC of the second track STR1 are the target sectors RSC. The write processing for the first track STR0 is executed ideally without any positioning error PE (PE ≈ 0 or PE = 0).

When the magnetic disk device 1 is affected by external vibration or the like during the write processing, a positioning error PE occurs when positioning the write head WHD. The positioning error PE is an amount of displacement from the target position of the write head WHD in the radial direction d1. By setting a track margin TM, the allowable range in which it is guaranteed that data on adjacent tracks can be read can be determined.

For example, when the write processing is executed on the second track STR1 and when the target sectors RSCe, RSC(e+1), and RSC(e+2) of the first track STR0 are adjacent to the write head WHD in the radial direction d1 during the period when the positioning error PE exceeds the track margin TM, it is determined (predicted) that the data in the target sectors RSCe, RSC(e+1), and RSC(e+2) of the first track STR0 are corrupted. BER of the data is desirably low, but the BER of the data of the target sectors RSCe, RSC(e+1), and RSC(e+2) of the first track STR0 exceeds a threshold value BERTH. Incidentally, as understood from the graph on the right side of FIG. 10, as the positioning error PE becomes greater, the adverse effect of adjacent track interference (ATI) becomes greater and the BER of the data on the first track STR0, which is adversely affected by ATI, becomes excessively high.

For this reason, the target sectors RSCe, RSC(e+1), and RSC(e+2) among the plurality of target sectors RSC of the first track STR0 are determined to be the corrupted target sectors CSC1, CSC2, and CSC3, respectively. This matter may lead to a situation that the quality of the signals obtained by reading the data in the corrupted target sectors CSC1 to CSC3 may be deteriorated or the data in the corrupted target sectors CSC1 to CSC3 may be erased.

In the example described with reference to FIG. 10, the magnetic disk device 1 does not comprise a function of executing track-based error correction for the data on the track TR. In this case, the error correction in track units is also referred to as error correction in units of tracks, track error correction code (ECC), or the like. For this reason, the target sectors RSCe, RSC(e+1), and RSC(e+2) remain the corrupted target sectors CSC1, CSC2, and CSC3, respectively.

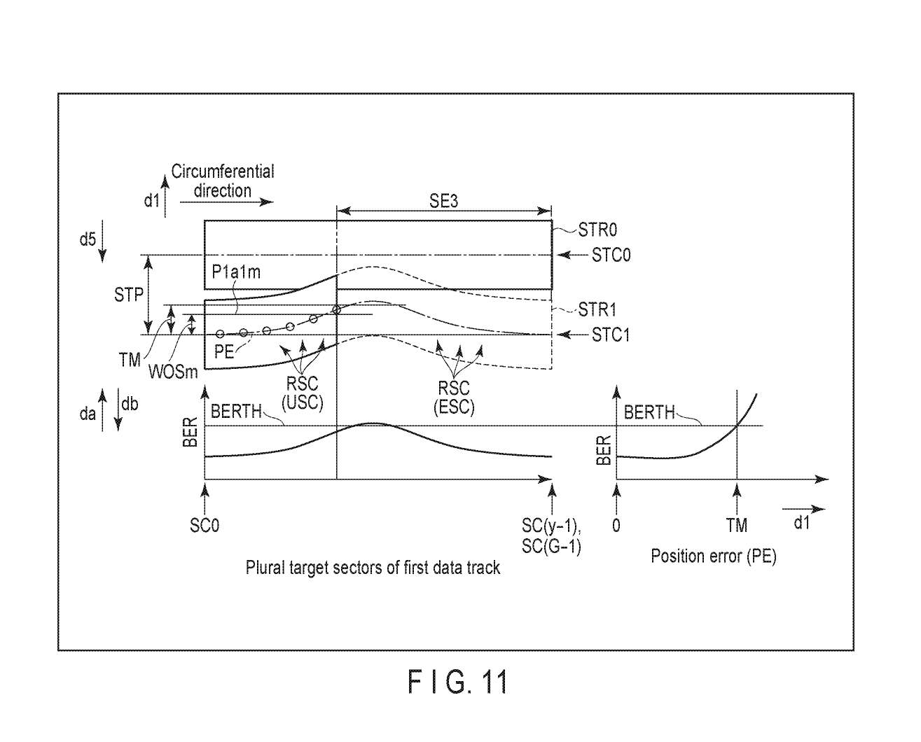

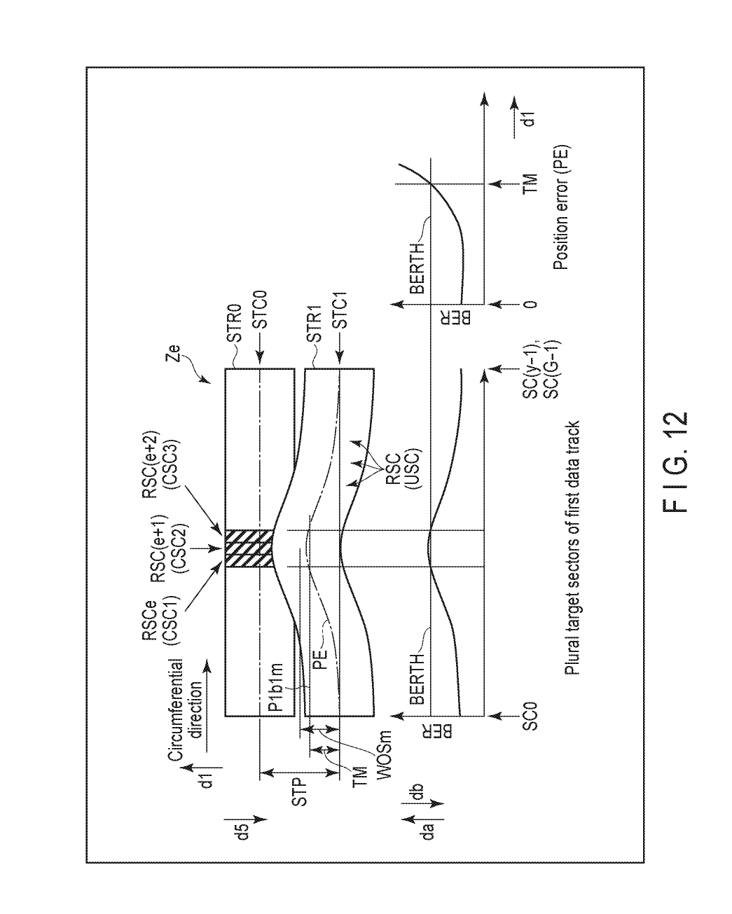

In FIG. 10, it has been described that all the target sectors RSC of the track TR have a common track margin TM. In the following descriptions of FIG. 11 and FIG. 12 as well, it will be explained that all the target sectors RSC of the track TR have a common track margin TM. However, the above-described setting of the track margin TM is just an example, and the track margin TM may be different for each target sector RSC.

FIG. 11 is a schematic diagram showing an example of the first track STR0 and the second track STR1 in a case where it is assumed that the magnetic disk device 1 does not comprise a function of executing the track-based error correction for the data of the track TR, illustrating the write processing for the first track STR0 and the second track STR1, illustrating a state in which a discrimination value is set to a write off-track slice WOS smaller (more severe) than the track margin TM and which the write processing for the second track STR1 is ended when it is detected that the position (positioning error PE) of the write head WHD crosses a fixed reference line P1a1m in a first direction da, and illustrating each of the change in BER for the first track STR0 and the change in BER for the positioning error PE in graph form. In FIG. 11 as well, the first track STR0 and the like are drawn by assuming the circumferential direction to be linear, for convenience of descriptions. In the descriptions made with reference to FIG. 11, it is assumed that the magnetic disk device 1 does not comprise the error correction unit 66 shown in FIG. 1.

As shown in FIG. 11, the first track STR0 and the second track STR1 are the data tracks, and all the sectors SC of the first track STR0 and all the sectors (data sectors) SC of the second track STR1 are the target sectors RSC. The write processing for the first track STR0 is executed ideally without any positioning error PE (PE ≈ 0 or PE = 0). The first track STR0 is located in the first direction da that is parallel to the radial direction d1 as seen from the second track STR1.

The write processing unit 62 can select the shingled magnetic recording of making the data of the second track STR1 overlap with the data of the first track STR0 in the overwriting direction d5 opposite to the first direction da and writing the data.

In order to prevent or suppress the write processing in a state where the positioning error PE exceeds the track margin TM, the magnetic disk device 1 has a write off-track slice WOSm. The fixed reference line P1a1m is a position offset by the write off-track slice WOSm in the first direction da from a track center STC1 of the second track STR1. When it is determined that the write head WHD (positioning error PE) has crossed the fixed reference line P1a1m in the first direction da, during the period of writing the data to the second track STR1, writing the data to the second track STR1 can be suspended. The remaining target sectors RSC for which data writing has been postponed, among the plurality of target sectors RSC of the second track STR1, become empty sectors ESC where no data is written. By avoiding the situation in which the absolute value of the positioning error PE exceeds the absolute value of the track margin TM, the occurrence of corrupted target sectors CSC on the first track STR0 can be prevented.

Incidentally, the track STR has a servo sector in addition to the sector SC which is the data sector. In the track STR, data sectors and servo sectors are generally provided alternately. The head HD (read head RHD) can derive the positioning error PE together with the servo sector. Therefore, the positioning error PE is generally the information which can be obtained intermittently.

To prevent |PE| > |TM|, the write off-track slice WOSm needs to be set such that |WOSm| ≤ |TM|. In order to avoid the situation in which |PE| > |TM|, the write off-track slice WOSm is desirably set such that |WOSm| < |TM|. Thus, the write processing for the second track STR1 can be suspended before the absolute value of the positioning error PE exceeds the absolute value of the track margin TM, and the situation in which the quality of the data on the first track STR0 is deteriorated can be avoided.

However, it needs to be noted that the write processing can be suspended more easily as the write off-track slice WOSm is set to be smaller, which leads to a decrease in the write performance of the magnetic disk device 1. Incidentally, when the write processing for the second track STR1 is suspended, in the magnetic disk device 1 which does not comprise the function of performing the error correction in track units or in which the function is invalidated, write retry processing of resuming the write processing for the second track STR1 after awaiting the rotation of the disk DK until |PE| ≤ |WOSm| is performed. Since the empty sector ESC of the second track STR1 can be changed to a recording sector USC, in the write retry processing, the situation in which the utilization efficiency of the second track STR1 remains low is avoided.

In FIG. 11, it has been described that all the target sectors RSC of the track TR have a common write off-track slice WOSm. In the following descriptions of FIG. 12 as well, it will be described that all the target sectors RSC of the track TR have a common write off-track slice WOSm. However, the above-described setting of the write off-track slice WOSm is an example, and the write off-track slice WOSm may be different for each target sector RSC.

FIG. 12 is a schematic diagram showing an example of the first track STR0 and the second track STR1 of the magnetic disk device 1 that comprises a function of executing the track-based error correction for the data of the track TR, illustrating the write processing for the first track STR0 and the second track STR1, illustrating a state in which a discrimination value is set to the write off-track slice WOSm greater (more loose) than the track margin TM and the write processing for the second track STR1 is continued until the track-based error correction for the first track STR0 reaches a limit, and illustrating each of the change in BER for the first track STR0 and the change in BER for the positioning error PE in graph form. In FIG. 12 as well, the first track STR0 and the like are drawn by assuming the circumferential direction to be linear, for convenience of descriptions.

As shown in FIG. 12, the write processing for the first track STR0 is executed ideally without any positioning error PE (PE ≈ 0 or PE = 0).

The magnetic disk device 1 comprises an error correction unit 66. When a corrupted target sector CSC occurs in the track ST, the read processing unit 63 can detect, together with the head amplifier IC 130, that a corrupted target sector CSC has occurred in the track ST, and the error correction unit 66 can execute the error correction processing to recover the data of the corrupted target sector CSC. For example, when a corrupted target sector CSC occurs in the first track STR0, the error correction unit 66 can recover the data of the corrupted target sector CSC, based on the user data of the plurality of elements of the target sectors RSC and the parity of the parity sector on the first track STR0.

The above parity sector is generated based on the user data of the plurality of elements of target sectors RSC of the first track STR0, and can be provided in part of the plurality of target sectors RSC of the first track STRb. For example, one or two target sectors RSC of the first track STR0 can be used as the parity sector or sectors. However, the above parity sectors may be provided in tracks TR other than the first track STR0. Alternatively, the above parity sectors may be provided in the memory other than the disk (for example, nonvolatile memory 90).

As described above, even when a corrupted target sector CSC occurs in the first track STR0, the error correction unit 66 can execute the error correction processing to recover the data of the corrupted target sector CSC. The occurrence of the corrupted target sector CSC in the first track STR0 can be therefore allowed. In the magnetic disk device 1 comprising the error correction unit 66, the write off-track slice WOSm can be set such that |WOSm| ≥ |TM|.

Incidentally, it needs to be noted that there is an upper limit for the number of corrupted target sectors for which the error correction unit 66 can execute the track-based error correction, in units of tracks TR. For example, when the number of corrupted target sectors CSC in the first track STR0 exceeds the upper limit (for example, 12), it is difficult for the error correction unit 66 to recover the data of all the corrupted target sectors CSC.

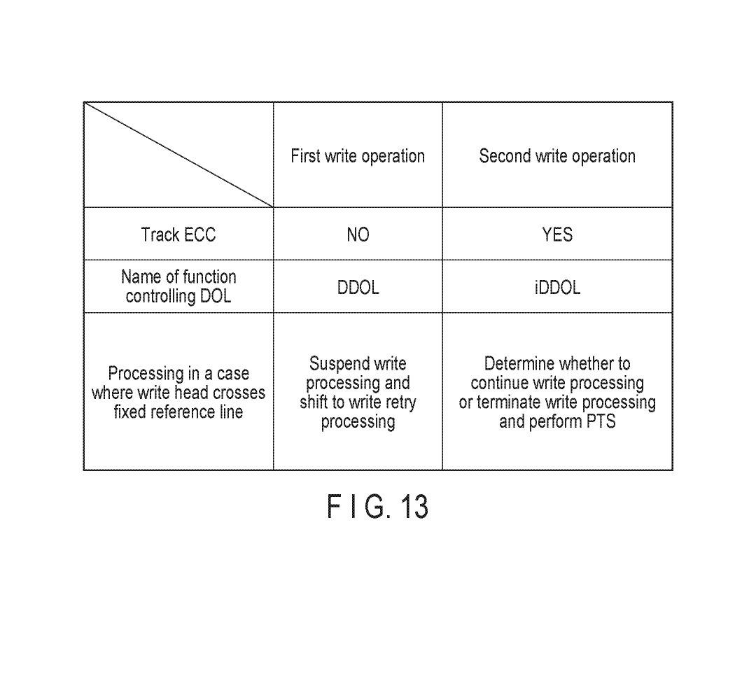

FIG. 13 is a table showing settings related to the presence or absence of the track ECC in the first and second write operations, the name of the function of controlling the DOL, and the processing performed in a case where the write head WHD (positioning error PE) crosses the fixed reference line P1a0m (or fixed reference line P1b0m) in the first direction da.

### First Write Operation

### Next, a first write operation will be described.

As shown in FIG. 13, FIG. 1, and FIG. 11, when it is assumed that the magnetic disk device 1 does not comprise the function of the track ECC, the magnetic disk device 1 can adopt the first write operation. The name of the function of controlling Drift-Off Level (DOL) is Dynamic Drift-Off Level (DDOL). The first write operation corresponds to the write operation disclosed with reference to FIG. 11.

When, after performing the write processing for the first track STR0 in the first write period, the write head WHD crosses the fixed reference line P1a1m in the first direction da in the second write period for performing the write processing for the second track STR1, the write processing for the second track STR1 is suspended before the absolute value of the positioning error PE exceeds the absolute value of the track margin TM. After that, write retry processing of resuming the write processing for the second track STR1 after waiting for the disk DK to rotate until |PE| ≤ |WOSm| is performed.

Incidentally, when the magnetic disk device 1 adopts the first write operation, the write retry processing such as the disk DK rotation wait operation, may occur frequently. As a result, it is difficult to improve the write performance of the magnetic disk device 1. Therefore, in order to improve the write performance of the magnetic disk device 1, the magnetic disk device 1 that adopts the second write operation comprises the function of the track ECC. In the magnetic disk device 1 that adopts the second write operation, the name of the function of controlling the DOL is intelligence Dynamic Drift-Off Level (iDDOL).

It is possible to allow a certain number of corrupted target sectors CSC to occur in the track STR, and it is possible to improve Track Per Inch (TPI) that is the track density in the radial direction d1.

### Second Write Operation

### Next, a second write operation will be described.

As shown in FIG. 13, FIG. 1, and FIG. 12, the error correction unit 66 can execute the error correction of the data in one or more corrupted target sectors CSC in which the data is considered to be corrupted, among the plurality of target sectors RSC of the first track STR0.

Focus on the second write period will be made here. During the second write period, the read processing unit 63 executes the seek processing of causing the read head RHD to seek and makes the write head WHD face the second track STR1.

Each time the data is written to each target sector RSC of the second track STR1, the correction limit discrimination unit 67 obtains information that the position of the write head WHD is shifted beyond the fixed reference line P1b1m in the first direction da.

When determining that the error correction of the data (user data) on the first track STR0, which is executed by the error correction unit 66, does not exceed the limit, based on the information obtained by the correction limit discrimination unit 67, the determination unit 64 can cause the write processing unit 62 to continue the write processing for the second track STR1. The degradation in write performance can be therefore suppressed.

Furthermore, when determining based on the above information that the error correction of the data on the first track STR0, which is performed by the error correction unit 66, exceeds the limit, the determination unit 64 can cause the write processing unit 62 to terminate the write processing for the second track STR1 and to activate Partial Track Slip (PTS) for saving the remaining data that could not be written to the second track STR1. In other words, the determination unit 64 does not perform the write processing for the remaining target sectors RSC of the second track STR1, but can save the remaining data that could not be written to the second track STR1 to a track other than the first track STR0 and the second track STR1.

### Comparative Example of First Write Operation

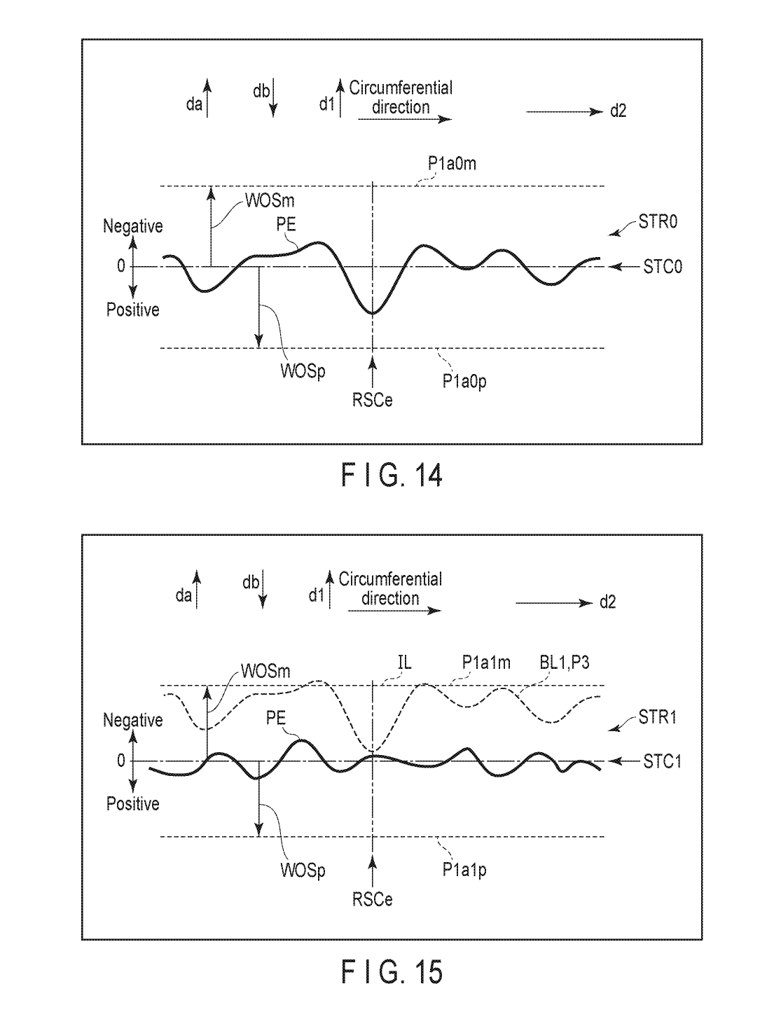

Next, a comparative example of the first write operation will be described. FIG. 14 is a diagram showing the change in positioning error PE when the magnetic disk device 1 performs the write processing on the first track STR0 in the first write operation, and showing a state in which the positioning error PE is not compared to a fixed additional line (fixed additional line P20 to be described later). FIG. 15 is a diagram showing the change in positioning error PE when the magnetic disk device 1 performs the write processing on the second track STR1 in the first write operation, and showing a state in which a variable reference line P3 is set to a first base line BL1, following FIG. 14.

As shown in FIG. 14, FIG. 15, and FIG. 1, the write processing unit 62 can set the target position of the write head WHD in the radial direction d1 to a first write target line (the track center STC0 of the first track STR0) extending in the circumferential direction of the disk DK, during the first write period when the data is written to the first track STR0. The write processing unit 62 can set the target position of the write head WHD in the radial direction d1 to a second write target line (the track center STC1 of the second track STR1) extending in the circumferential direction, during the second write period when the data is written to the second track STR1.

The determination unit 64 can determine whether the write head WHD has crossed a fixed reference line P1a0p in the second direction db, during the first write period. In this case, the second direction db is a direction opposite to the first direction da, i.e., a reverse direction of the first direction da. Regarding the relationship between the first direction da and the second direction db, “opposite” means “exactly opposite”, and “reverse” means “completely opposite”. The fixed reference line P1a0p extends in the circumferential direction and is located at a position shifted in the second direction db from the first write target line (STC0).

The fixed reference line P1a0p is located at a position offset in the second direction db by the write off-track slice WOSp from the first write target line (STC0). Incidentally, a fixed reference line P1a1p is located at a position offset in the second direction db by the write off-track slice WOSp from the second write target line (STC1).

The fixed reference line P1a0m is a position offset by the write off-track slice WOSm in the first direction da from the first write target line (STC0). Incidentally, the fixed reference line P1a1m is a position offset by the write off-track slice WOSm in the first direction da from the second write target line (STC1).

The position of the first write target line (STC0) or the second write target line (STC1) in the radial direction d1 is referred to as 0 (zero), the second direction db from the first write target line (STC0) or the second write target line (STC1) is referred to as being positive, and the first direction da from the first write target line (STC0) or the second write target line (STC1) is referred to as being negative. The write off-track slice WOSp is a positive value, and the write off-track slice WOSm is a negative value.

The determination unit 64 can control the write processing for the first track STR0, based on information indicating whether the write head WHD has crossed the fixed reference line P1a0p in the second direction db. However, the determination unit 64 cannot control the write processing for the second track STR1, based on the information indicating whether the write head WHD has crossed the fixed additional line (P20) in the second direction db.

When the determination unit 64 determines that the write head WHD has not crossed the fixed reference line P1a0p in the second direction db, during the first write period, the determination unit 64 can cause the write processing unit 62 to continue the write processing unit 62 for the first track STR0. The adjustment unit 65 generates a first base line BL1 by shifting the initial line IL in a section where the write head WHD has not crossed the fixed reference line P1a0p in the second direction db in the circumferential direction, in a direction parallel to the radial direction d1 by the amount of variation in the position of the write head WHD in the radial direction d1, and can update the variable reference line P3 in the above section from the initial line IL to the first base line BL1.

The initial line IL extends in the circumferential direction and is located at a position shifted in the first direction da from the second write target line (STC1). The initial line IL is, for example, a line overlapping with the fixed reference line P1a1m, but is not limited to this. The initial line IL may also be a line shifted in the radial direction d1 from the fixed reference line P1a1m. The first base line BL1 is not the trajectory of the positioning error PE in a case where data is written to the first track STR0, but a line based on the positioning error PE in a case where data is written to the first track STR0. For example, the more the positioning error PE is shifted in the first direction da in a case where data is written to the first track STR0, the more the first base line BL1 is located in the first direction da side. Similarly, the more the positioning error PE is shifted in the second direction db, the more the first base line BL1 is positioned in the second direction db side.

When the determination unit 64 determines that the write head WHD has crossed the fixed reference line P1a0p in the second direction db, during the first write period, the determination unit 64 can control the operation of the write processing unit 62, and the adjustment unit 65 can maintain the variable reference line P3 in a section where the write head WHD has crossed the fixed reference line P1a0p in the second direction db in the circumferential direction, as the initial line IL.

When the determination unit 64 determines that the write head WHD has not crossed the variable reference line P3 in the first direction da, during the second write period, the determination unit 64 can cause the write processing unit 62 to continue the write processing for the second track STR1.

When the determination unit 64 determines that the write head WHD has crossed the variable reference line P3 or the fixed reference line P1a1m in the first direction da, during the second write period, the determination unit 64 can control the operation of the write processing unit 62 and cause the write processing unit 62 to suspend the write processing for the second track STR1. After suspending the write processing for the second track STR1, the target position of the write head WHD is maintained on the second write target line (STC1), and the system waits for the disk DK to rotate. Then, after the write head WHD reaches a state of not crossing either the variable reference line P3 or the fixed reference line P1a1m in the first direction da, the write retry processing of resuming the write processing for the second track STR1 can be performed.

Incidentally, it can be understood that when the data is written to the target sector RSCe of the second track STR1, during the above-described second write period, the position of the write head WHD (positioning error PE) becomes very close to the variable reference line P3 (first base line BL1). In this case, adverse effects of ATI may extend to the target sector RSCe of the first track STR0, which is adjacent to the target sector RSCe of the second track STR1, and the target sector RSCe of the first track STR0 may become a corrupted target sector (CSC). In other words, a read error may occur when reading the data from the target sector RSCe of the first track STR0.

Therefore, write processing that makes it difficult to generate a corrupted target sector (CSC) on the first track STR0, even when writing data to the second track STR1 is performed in the examples of the first write operation and the second write operation to be described later.

### Example of First Write Operation

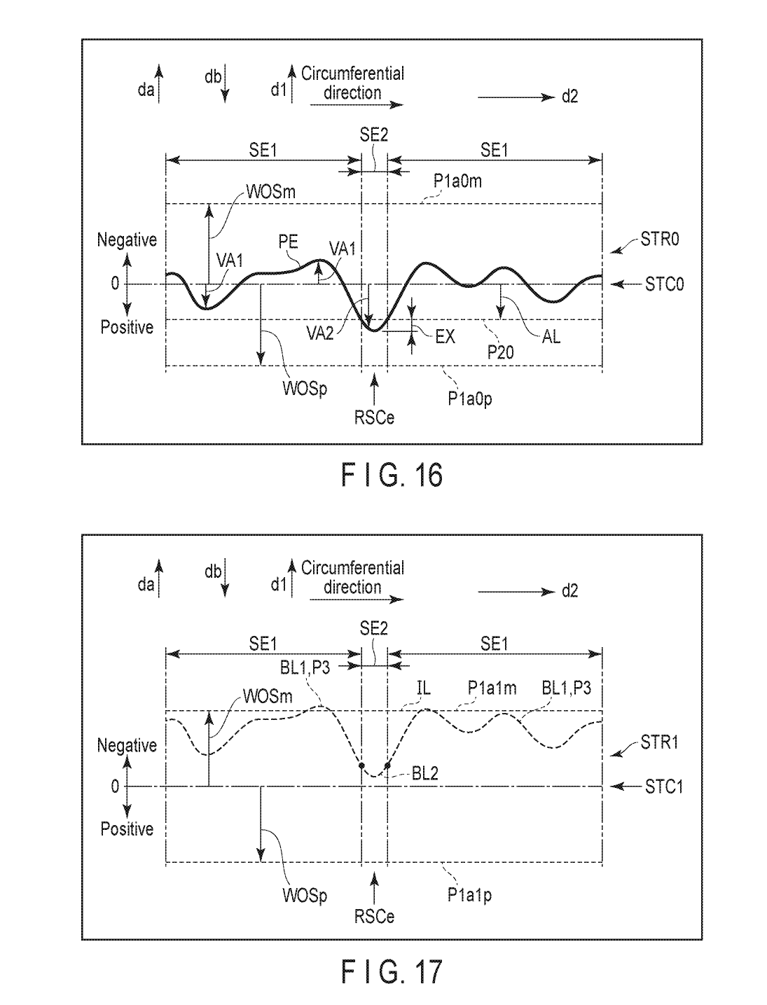

Next, an example of the first write operation will be described. FIG. 16 is a diagram showing the change in positioning error PE when the magnetic disk device 1 performs the write processing on the first track STR0 in the first write operation, and showing a state in which the positioning error PE is compared to the fixed additional line P20. FIG. 17 is a diagram showing a state in which the variable reference line P3 is set to the first base line BL1 and a second base line BL2 when the magnetic disk device 1 performs the write processing on the second track STR1 in the first write operation, following FIG. 16.

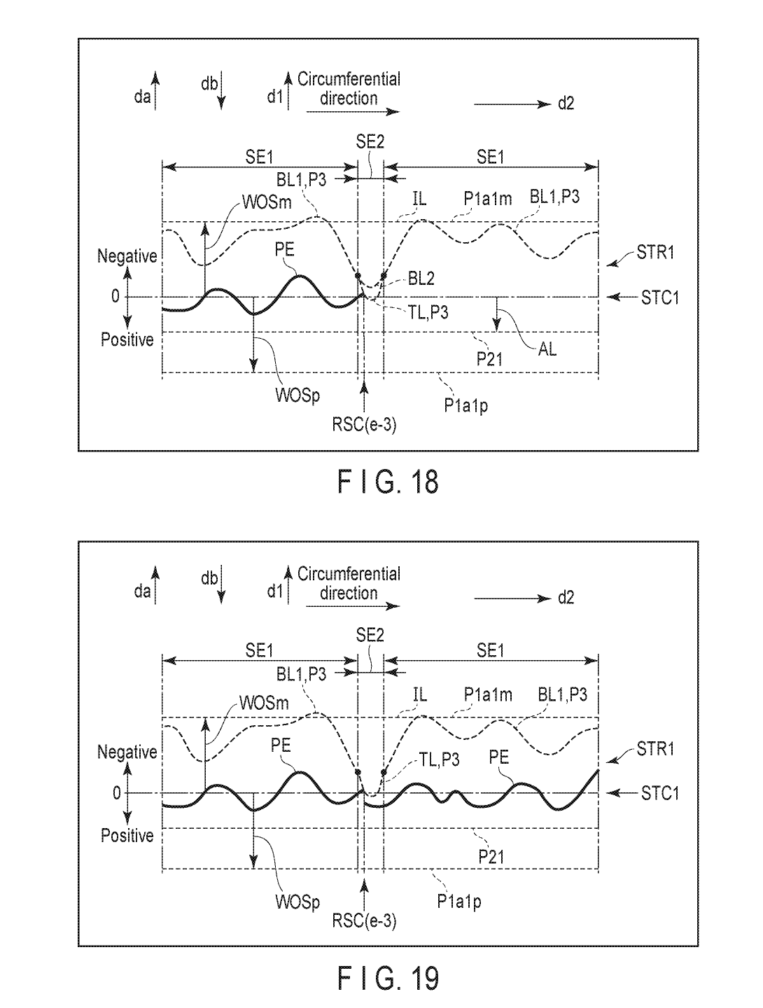

FIG. 18 is a diagram showing the change in positioning error PE when the magnetic disk device 1 performs the write operation on the second track STR1 in the first write operation in a state in which the variable reference line P3 is updated to a strict line TL, and showing a state in which the write processing on the second track STR1 is suspended during the processing, following FIG. 17. FIG. 19 is a diagram showing a state in which the magnetic disk device 1 resumes the write processing on the second track STR1 in the first write operation during the processing, following FIG. 18.

As shown in FIG. 16 - FIGS. 19 and 1. the write processing unit 62 can set the target position of the write head WHD in the radial direction d1 to the first write target line (the track center STC0 of the first track STR0) extending in the circumferential direction of the disk DK, during the first write period when the data is written to the first track STR0. The write processing unit 62 can set the target position of the write head WHD in the radial direction d1 to a second write target line (the track center STC1 of the second track STR1) extending in the circumferential direction, during the second write period when the data is written to the second track STR1.

The determination unit 64 can determine whether the write head WHD has crossed each of the fixed reference line P1a0p and the fixed additional line P20 in the second direction db, during the first write period. The fixed reference line P1a0p extends in the circumferential direction and is located at a position shifted in the second direction db from the first write target line (STC0).

The fixed reference line P1a0p is located at a position offset in the second direction db by the write off-track slice WOSp from the first write target line (STC0). Incidentally, a fixed reference line P1a1p is located at a position offset in the second direction db by the write off-track slice WOSp from the second write target line (STC1).

The fixed additional line P20 extends in the circumferential direction, and is located at a position shifted in the second direction db from the first write target line (STC0), and is located at a position shifted in the first direction da from the fixed reference line P1a0p.

The fixed additional line P20 is a position offset by a distance AL in the second direction db from the first write target line (STC0). Incidentally, the fixed additional line P21 is a position offset by the distance AL in the second direction db from the second write target line (STC1). The fixed additional line P20 and the fixed additional line P21 have positive values.

The determination unit 64 can control the write processing for the first track STR0, based on the information indicating whether the write head WHD has crossed the fixed reference line P1a0p in the second direction db, and can control the write processing for the second track STR1, based on the information indicating whether the write head WHD has crossed the fixed additional line P20 in the second direction db.

When the determination unit 64 determines that the write head WHD has not crossed the fixed additional line P20 in the second direction db, during the first write period, the determination unit 64 can cause the write processing unit 62 to continue the write processing for the first track STR0, and the adjustment unit 65 can generate the first base line BL1 by shifting the initial line IL in the first section SE1 where the write head WHD has not crossed the fixed additional line P20 in the second direction db in the circumferential direction, in a direction parallel to the radial direction d1 by an amount corresponding to the first variation amount VA1 of the position of the write head WHD in the radial direction d1, and can update the variable reference line P3 in the first section SE1 from the initial line IL to the first base line BL1.

When the determination unit 64 determines that the write head WHD has crossed the fixed additional line P20 in the second direction db but has not crossed the fixed reference line P1a0p in the second direction db, during the first write period, the determination unit 64 can cause the write processing unit 62 to continue the write processing for the first track STR0.

A section where the write head WHD crosses the fixed additional line P20 in the second direction db in the circumferential direction but does not cross the fixed reference line P1a0p in the second direction db is defined as a second section SE2. The adjustment unit 65 can generate a second base line BL2 by shifting the initial line IL in the second section SE2, in the second direction db, by an amount corresponding to the second variation amount VA2 of the position of the write head WHD in the radial direction d1. Furthermore, the adjustment unit 65 can generate a strict line TL by shifting the second base line BL2 in the second section SE2, in the second direction db, by an amount corresponding to an excess amount EX by which the write head WHD has crossed the fixed additional line P20 in the second direction db, and can update the variable reference line P3 in the second section SE2 from the initial line IL to the strict line TL.

In the example of the first write operation, the point that the variable reference line P3 in the second section SE2 can be updated from the initial line IL to the strict line TL is a point that cannot be achieved in the comparative example of the above-described first write operation.

The initial line IL extends in the circumferential direction and is located at a position shifted in the first direction da from the second write target line (STC1). The initial line IL is, for example, a line overlapping with the fixed reference line P1a1m, but is not limited to this. The initial line IL may also be a line shifted in the radial direction d1 from the fixed reference line P1a1m. The first base line BL1 and the second base line BL2 are not the trajectory of the positioning error PE in a case where data is written to the first track STR0, but lines based on the positioning error PE in a case where data is written to the first track STR0. For example, the more the positioning error PE is shifted in the first direction da in a case where data is written to the first track STR0, the more the first base line BL1 is located in the first direction da side. Similarly, the more the positioning error PE is shifted in the second direction db, the more the first base line BL1 and the second base line BL2 are located in the second direction db side. The fixed reference line P1a1m extends in the circumferential direction and is located at a position shifted in the first direction da from the second write target line (STC1).

When the determination unit 64 determines that the write head WHD has crossed the fixed additional line P20 in the second direction db and further crossed the fixed reference line P1a0p in the second direction db, during the first write period, the determination unit 64 can control the operation of the write processing unit 62, and the adjustment unit 65 can maintain the variable reference line P3 in a third section where the write head WHD has crossed the fixed reference line P1a0p in the second direction db in the circumferential direction, as the initial line IL.

When the determination unit 64 determines that the write head WHD has crossed the variable reference line P3 or the fixed reference line P1a1m in the first direction da, during the second write period, the determination unit 64 can control the operation of the write processing unit 62 and cause the write processing unit 62 to suspend the write processing for the second track STR1. The fixed reference line P1a1m is referred to as another fixed reference line. Alternatively, the fixed reference line P1a0p is referred to as a first fixed reference line, and the fixed reference line P1a1m is referred to as a second fixed reference line.

the target sector RSC that serves as the starting point for suspending the write processing, among a plurality of target sectors RSC of the second track STR1, is the target sector that the write head WHD faces immediately after detecting that the write head WHD first crosses the variable reference line P3 or the fixed reference line P1a1m in the first direction da. In this case, the target sector is target sector RSC(e-3).

When the determination unit 64 determines that the write head WHD has not crossed the variable reference line P3 or the fixed reference line P1a1m in the first direction da, during the second write period, the determination unit 64 can cause the write processing unit 62 to continue the write processing for the second track STR1.

After the determination unit 64 has caused the write processing unit 62 to suspend the write processing for the second track STR1, during the second write period, the determination unit 64 causes the write processing unit 62 to maintain the target position of the write head WHD on the second write target line (STC1) and waits for the disk DK to rotate. Then, after the write head WHD reaches a state of not crossing either the variable reference line P3 or the fixed reference line P1a1m in the first direction da, the determination unit 64 can cause the write processing unit 62 to perform the write retry processing of resuming the write processing for the second track STR1 from a target sector RSC(e-3) that is the starting point.

As described above, since the variable reference line P3 in the second section SE2 can be updated from the initial line IL to the strict line TL, it is possible to avoid a situation in which adverse effects of ATI may extend to the target sector RSC (e-3) of the first track STR0, which is adjacent to the target sector RSC(e-3) of the second track STR1, and to prevent the target sector RSC (e-3) of the first track STR0, and the like, from becoming a corrupted target sector (CSC). The data of the target sector RSC located in the second section SE2 among the plurality of target sectors RSC of the first track STR0 can be further protected.

The recording medium of the magnetic disk device 1 can store information regarding each of the fixed reference line P1a, the fixed additional line P2, the initial line IL, the first base line BL1, the second base line BL2, the strict line TL, and the variable reference line P3, which have been described above. Examples of the above-mentioned storage medium include the volatile memory 70, the non-volatile memory 90, the disk DK, and the like. The above-mentioned storage medium may be a storage medium other than the volatile memory 70, the non-volatile memory 90, and the disk DK.

Incidentally, when the power is cut off while the volatile memory 70 is used as the above-mentioned storage medium, the data recorded in the volatile memory 70 may be saved to a nonvolatile storage medium such as the nonvolatile memory 90.

### Example of Second Write Operation

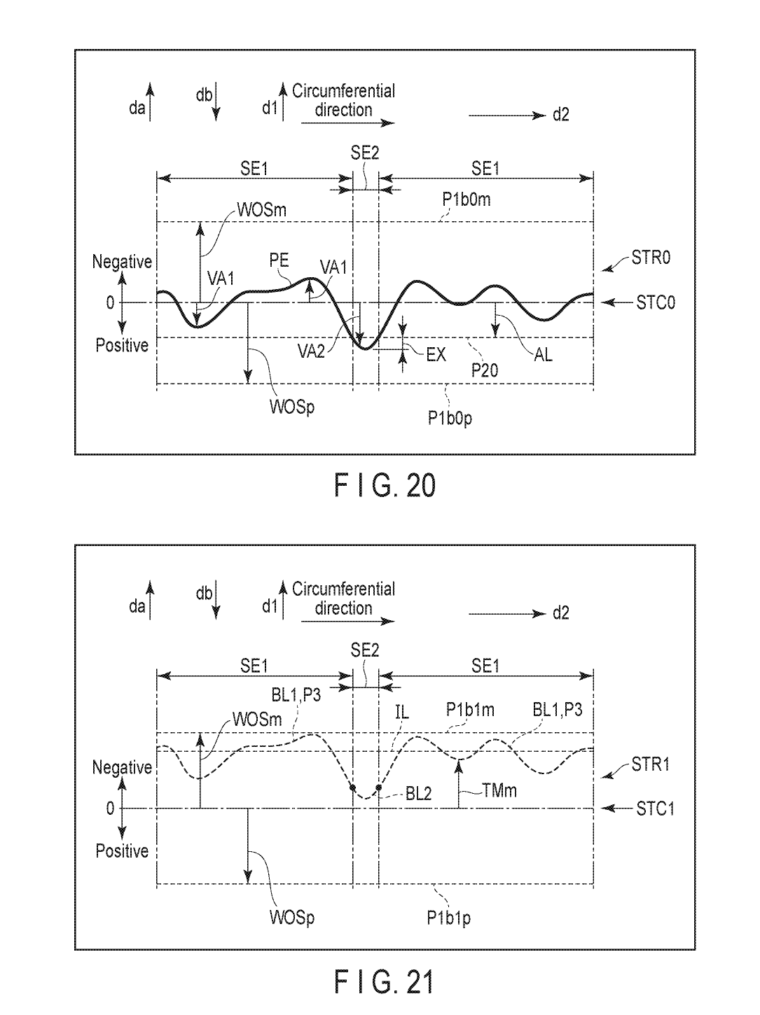

Next, an example of the second write operation will be described. FIG. 20 is a diagram showing the change in positioning error PE when the magnetic disk device 1 performs the write processing on the first track STR0 in the second write operation, and showing a state in which the positioning error PE is compared to the fixed additional line P20.

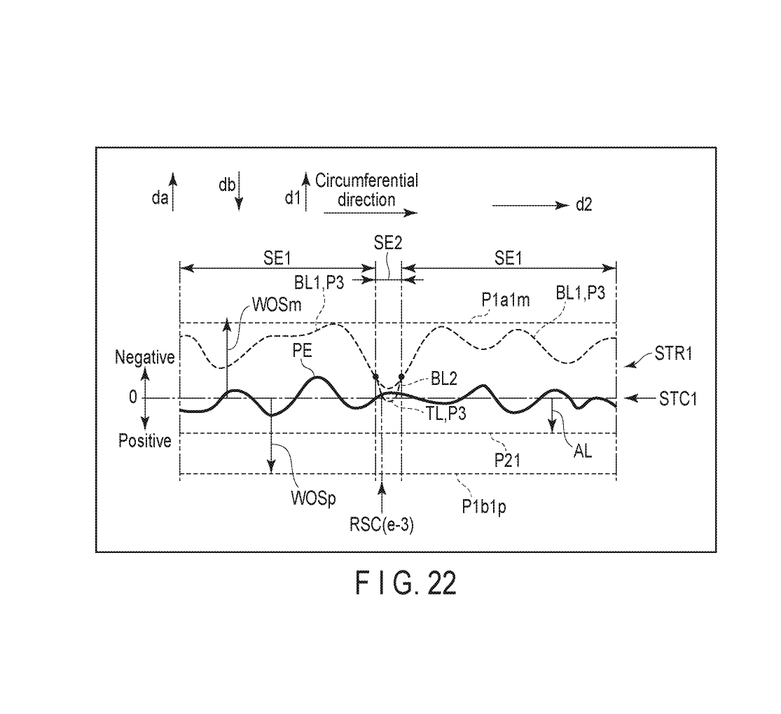

FIG. 21 is a diagram showing a state in which the variable reference line P3 is set to the first base line BL1 and a second base line BL2 when the magnetic disk device 1 performs the write processing on the second track STR1 in the second write operation, following FIG. 20. FIG. 22 is a diagram showing the change in positioning error PE when the magnetic disk device 1 performs the write processing on the second track STR1 in the second write operation in a state in which the variable reference line P3 is updated to the strict line TL, following FIG. 21.

As shown in FIG. 20 to FIG. 22, and FIG. 1, the write processing unit 62 can set the target position of the write head WHD in the radial direction d1 to the first write target line (the track center STC0 of the first track STR0) extending in the circumferential direction of the disk DK, during the first write period when the data is written to the first track STR0. The write processing unit 62 can set the target position of the write head WHD in the radial direction d1 to a second write target line (the track center STC1 of the second track STR1) extending in the circumferential direction, during the second write period when the data is written to the second track STR1.

The determination unit 64 can determine whether the write head WHD has crossed each of a fixed reference line P1b0p and the fixed additional line P20 in the second direction db, during the first write period. The fixed reference line P1b0p extends in the circumferential direction and is located at a position shifted in the second direction db from the first write target line (STC0).

The fixed reference line P1b0p is located at a position offset in the second direction db by the write off-track slice WOSp from the first write target line (STC0). Incidentally, a fixed reference line P1b1p is located at a position offset in the second direction db by the write off-track slice WOSp from the second write target line (STC1).

The fixed additional line P20 extends in the circumferential direction, and is located at a position shifted in the second direction db from the first write target line (STC0), and is located at a position shifted in the first direction da from the fixed reference line P1b0p.

The fixed additional line P20 is a position offset by a distance AL in the second direction db from the first write target line (STC0). Incidentally, the fixed additional line P21 is a position offset by the distance AL in the second direction db from the second write target line (STC1). The fixed additional line P20 and the fixed additional line P21 have positive values.

The determination unit 64 can control the write processing for the first track STR0, based on the information indicating whether the write head WHD has crossed the fixed reference line P1b0p in the second direction db, and can control the write processing for the second track STR1, based on the information indicating whether the write head WHD has crossed the fixed additional line P20 in the second direction db.

When the determination unit 64 determines that the write head WHD has not crossed the fixed additional line P20 in the second direction db, during the first write period, the determination unit 64 can cause the write processing unit 62 to continue the write processing for the first track STR0, and the adjustment unit 65 can generate the first base line BL1 by shifting the initial line IL in the first section SE1 where the write head WHD has not crossed the fixed additional line P20 in the second direction db in the circumferential direction, in a direction parallel to the radial direction d1 by an amount corresponding to the first variation amount VA1 of the position of the write head WHD in the radial direction d1, and can update the variable reference line P3 in the first section SE1 from the initial line IL to the first base line BL1.

When the determination unit 64 determines that the write head WHD has crossed the fixed additional line P20 in the second direction db but has not crossed the fixed reference line P1b0p in the second direction db, during the first write period, the determination unit 64 can cause the write processing unit 62 to continue the write processing for the first track STR0.

A section where the write head WHD crosses the fixed additional line P20 in the second direction db in the circumferential direction but does not cross the fixed reference line P1b0p in the second direction db is defined as a second section SE2. The adjustment unit 65 can generate a second base line BL2 by shifting the initial line IL in the second section SE2, in the second direction db, by an amount corresponding to the second variation amount VA2 of the position of the write head WHD in the radial direction d1. Furthermore, the adjustment unit 65 can generate a strict line TL by shifting the second base line BL2 in the second section SE2, in the second direction db, by an amount corresponding to an excess amount EX by which the write head WHD has crossed the fixed additional line P20 in the second direction db, and can update the variable reference line P3 in the second section SE2 from the initial line IL to the strict line TL.

In the example of the second write operation as well, the strict line TL can be derived in the same manner as the example of the first write operation.

The initial line IL extends in the circumferential direction and is located at a position shifted in the first direction da from the second write target line (STC1). The initial line IL is, for example, a line overlapping with the fixed reference line P1b1m, but is not limited to this. The initial line IL may also be a line shifted in the radial direction d1 from the fixed reference line P1b1m. The first base line BL1 and the second base line BL2 are not the trajectory of the positioning error PE in a case where data is written to the first track STR0, but lines based on the positioning error PE in a case where data is written to the first track STR0. For example, the more the positioning error PE is shifted in the first direction da in a case where data is written to the first track STR0, the more the first base line BL1 is located in the first direction da side. Similarly, the more the positioning error PE is shifted in the second direction db, the more the first base line BL1 and the second base line BL2 are located in the second direction db side. The fixed reference line P1b1m extends in the circumferential direction and is located at a position shifted in the first direction da from the second write target line (STC1).

When the determination unit 64 determines that the write head WHD has crossed the fixed additional line P20 in the second direction db and further crossed the fixed reference line P1b0p in the second direction db, during the first write period, the determination unit 64 can control the operation of the write processing unit 62, and the adjustment unit 65 can maintain the variable reference line P3 in a third section where the write head WHD has crossed the fixed reference line P1b0p in the second direction db in the circumferential direction, as the initial line IL.

When the determination unit 64 determines that the write head WHD has crossed the variable reference line P3 or the fixed reference line P1b1m in the first direction da, during the second write period, the determination unit 64 can control the operation of the write processing unit 62.

In contrast, when the determination unit 64 determines that the write head WHD has not crossed the variable reference line P3 or the fixed reference line P1b1m in the first direction da, during the second write period, the determination unit 64 can cause the write processing unit 62 to continue the write processing for the second track STR1.

Each time the data is written to each target sector RSC of the second track STR1, during the second write period, the correction limit discrimination unit 67 can acquire information that the position of the write head WHD is crossing the variable reference line P3 in the first direction da.

When the determination unit 64 determines that the error correction of the data on the first track STR0, which is executed by the error correction unit 66, does not exceed the limit, based on the above information obtained by the correction limit discrimination unit 67, the determination unit 64 can cause the write processing unit 62 to continue the write processing for the second track STR1.

In contrast, when the determination unit 64 determines that the error correction of the data on the first track STR0, which is executed by the error correction unit 66, has exceeded the limit, based on the above information, the determination unit 64 can cause the write processing unit 62 to terminate the write processing for the second track STR1.

When the determination unit 64 causes the write processing unit 62 to terminate the write processing for the second track STR1, during the second write period, the write processing unit 62 can initiate PTS to relocate the remaining data that could not be written to the second track STR1 to a recording area other than the first track STR0 and the second track STR1.

The second write operation comprises the function of the track ECC. Therefore, when the function of the track ECC is set to be enabled, the write processing for the second track STR1 can be continued even when the write head WHD crosses the variable reference line P3 (strict line TL) in the first direction da during the write processing for the target sector RSC (e-3) of the second track STR1.

As described above, since the variable reference line P3 in the second section SE2 can be updated from the initial line IL to the strict line TL, it becomes difficult for ATI to adversely affect the target sectors RSC located in the second section SE2 among the plurality of target sectors RSC of the first track STR0. Then, the data of the target sector RSC located in the second section SE2 can be further protected.

The criteria for determining whether error correction of the data on the first track STR0, which is performed by the error correction unit 66, has reached its limit will be explained.

Each time the data is written to each target sector RSC of the second track STR1, the correction limit discrimination unit 67 can measure the actual excess amount by which the position of the write head WHD crosses the variable reference line P3 of the write head WHD in the first direction da, and update the cumulative actual excess amount, which is the cumulative total of the actual excess amount, inside the recording medium of the magnetic disk device 1. In this case, the information obtained by the correction limit discrimination unit 67 is the cumulative actual excess amount.

When the determination unit 64 determines that the cumulative actual excess amount is smaller than or equal to the upper limit threshold value, during the second write period, the determination unit 64 can cause the write processing unit 62 to continue the write processing for the second track STR1. The above-mentioned upper limit threshold value is a value indicating the limit of a range in which the error correction for the first track STR0 can be performed.

In contrast, when the determination unit 64 determines that the cumulative actual excess amount has exceeded the above-mentioned upper limit threshold value, during the second write period, the determination unit 64 can cause the write processing unit 62 to terminate the write processing for the second track STR1.

When determining the error correction limit, the determination may be based on the number of times at which the write head WHD crosses the variable reference line P3 in the first direction da.

In this case, the correction limit discrimination unit 67 can count the number of one or more corrupted target sectors CSC on the first track STR0 and update the cumulative number that is the above-described cumulative count, in the recording medium of the magnetic disk device 1. The information obtained by the correction limit discrimination unit 67 further includes the cumulative number.

When the determination unit 64 determines that the cumulative actual excess amount is smaller than or equal to the upper limit threshold value and that the cumulative count is smaller than or equal to the upper limit count, during the second write period, the determination unit 64 can cause the write processing unit 62 to continue the write processing for the second track STR1. The above-mentioned upper limit number is the number indicating the limit of a range in which the error correction for the first track STR0 can be performed.

In contrast, when the determination unit 64 determines that the cumulative count has exceeded the upper limit count, during the second write period, the determination unit 64 can cause the write processing unit 62 to terminate the write processing for the second track STR1.

The recording medium of the magnetic disk device 1 can store information regarding each of the fixed reference line P1a, the fixed additional line P2, the initial line IL, the first base line BL1, the second base line BL2, the strict line TL, the variable reference line P3, which have been described above, and the cumulative measured excess amount, the upper limit threshold value, the cumulative count, and the upper limit count. Examples of the above-mentioned storage medium include the volatile memory 70, the non-volatile memory 90, the disk DK, and the like. The above-mentioned storage medium may be a storage medium other than the volatile memory 70, the non-volatile memory 90, and the disk DK.

Incidentally, when the power is cut off while the volatile memory 70 is used as the above-mentioned storage medium, the data recorded in the volatile memory 70 may be saved to a nonvolatile storage medium such as the nonvolatile memory 90.

According to the magnetic disk device 1 and the write processing method of the embodiment configured as described above, the magnetic disk device 1 comprises the disk DK, the head HD, the read processing unit 63, the write processing unit 62, the determination unit 64, and the like.

The determination unit 64 determines whether the write head WHD has crossed each of the fixed reference line P1a0p (or P1b0p) and the fixed additional line P20 in the second direction db, during the first write period. The determination unit 64 can control the write processing for the first track STR0, based on the information indicating whether the write head WHD has crossed the fixed reference line P1a0p (or P1b0p) in the second direction db, and can control the write processing for the second track STR1, based on the information indicating whether the write head WHD has crossed the fixed additional line P20 in the second direction db.

Based on the above, a magnetic disk device 1 and a write processing method capable of controlling the writing processing to the disk DK based on the plurality of elements of information can be obtained in the present embodiment.

Furthermore, the variable reference line P3 in the second section SE2 can be tightly compressed from the second base line BL2 to the strict line TL. Since the adverse effects of ATI on the first track STR0 during the write processing for the second track STR1 can be strictly managed, it is possible to further contribute to the preservation of the data on the first track STR0.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the above-described technology may be applied not only to the magnetic disk devices of hybrid recording, but also to magnetic disk devices of shingled magnetic recording.

What is claimed is:

1. A magnetic disk device comprising:
a disk having a first data track and a second data track adjacent to each other in a recording layer, the first data track and the second data track each including a plurality of target sectors being targets to which data is written, the first data track being located in a first direction parallel to a radial direction of the disk as viewed from the second data track;
a head including a write head writing data to the recording layer and a read head reading data from the recording layer;
a read processing unit capable of deriving position information of the write head in the radial direction by seeking the read head; and
a write processing unit capable of performing write processing of writing data to the recording layer, the write processing unit setting a target position of the write head in the radial direction to a first write target line extending in a circumferential direction of the disk during a first write period for writing data to the first data track, and setting the target position of the write head in the radial direction to a second write target line extending in the circumferential direction during a second write period for writing data to the second data track; and
a determination unit performing a following process during the first write period: determining whether the write head has crossed each of the fixed reference line and the fixed additional line in a second direction opposite to the first direction; controlling the write processing for the first data track based on information indicating whether the write head has crossed the fixed reference line in the second direction; and controlling the write processing for the second data track based on information indicating whether the write head has crossed the fixed additional line in the second direction.

2. The magnetic disk device of claim 1, wherein
the fixed reference line extends in the circumferential direction and is located at a position shifted in the second direction from the first write target line, and
the fixed additional line extends in the circumferential direction, and is located at a position shifted in the second direction from the first write target line and a position shifted in the first direction from the fixed reference line.

3. The magnetic disk device of claim 2, further comprising:
an adjustment unit, wherein
when the determination unit determines that the write head has not crossed the fixed additional line in the second direction, during the first write period, the determination unit causes the write processing unit to continue the write processing for the first data track, and the adjustment unit generates the first base line by shifting the initial line in the first section where the write head has not crossed the fixed additional line in the second direction in the circumferential direction, in a direction parallel to the radial direction by an amount corresponding to the first variation amount of the position of the write head in the radial direction, and updates the variable reference line in the first section from the initial line to the first base line,
when the determination unit determines that the write head has crossed the fixed additional line in the second direction that the write head has not crossed the fixed reference line in the second direction, the determination unit causes the write processing unit to continue the write processing for the first data track, and the adjustment unit generates the second base line by shifting the initial line in a second section where the write head has crossed the fixed additional line in the second direction and has not crossed the fixed reference line in the second direction, in the circumferential direction, by an amount corresponding to a second variation amount of the position of the write head in the radial direction, and generates a strict line by shifting the second base line in the second section by an amount corresponding to an excessive amount at which the write head has crossed the fixed additional line in the second direction, and updates the variable reference line in the second section from the initial line to the strict line,
when the determination unit determines that the write head has crossed the fixed additional line in the second direction and further crossed the fixed reference line in the second direction, the determination unit controls an operation of the write processing unit, and the adjustment unit maintains the variable reference line in a third section where the write head has crossed the fixed reference line in the second direction in the circumferential direction, as the initial line,
during the second write period following the first write period,
when the determination unit determines that the write head has not crossed the variable reference line or another fixed reference line in the first direction, the determination unit causes the write processing unit to continue the write processing for the second data track,
when the determination unit determines that the write head has crossed the variable reference line or the other fixed reference line in the first direction, the determination unit controls an operation of the write processing unit,
the initial line extends in the circumferential direction and is located at a position shifted in the first direction from the second write target line, and
the other fixed reference line extends in the circumferential direction and is located at a position shifted in the first direction from the second write target line.

4. The magnetic disk device of claim 3, further comprising:
a recording medium capable of storing information regarding each of the fixed reference line, the fixed additional line, the initial line, the first base line, the second base line, the strict line, and the variable reference line.

5. The magnetic disk device of claim 3, wherein
during the second write period, when the determination unit determines that the write head has crossed the variable reference line or the other fixed reference line in the second direction, the determination unit causes the write processing unit to suspend the write processing for the second data track, and
the target sector serving as a starting point for suspending the write processing, among the plurality of target sectors of the second data track, is a target sector which the write head faces immediately after detecting that the write head has first crossed the variable reference line or the other fixed reference line in the first direction.

6. The magnetic disk device of claim 5, wherein
after causing the write processing unit to suspend the write processing for the second data track, during the second write period, the determination unit causes the write processing unit to maintain the target position of the write head on the second write target line, waits for the disk to rotate, and causes the write processing unit to perform write retry processing of resuming the write processing for the second data track from a target sector serving as the starting point.

7. The magnetic disk device of claim 3, further comprising:
an error correction unit performing error correction of data in one or more corrupted target sectors whose data is determined to be corrupted, among the plurality of target sectors of the first data track; and
a correction limit discrimination unit, wherein
during the second write period,
each time data is written to each of the target sectors of the second data track, the correction limit discrimination unit obtains information that the position of the write head crosses the variable reference line in the first direction,
when determining that the error correction of the data on the first data track, which is performed by the error correction unit, does not exceed a limit, based on the information obtained by the correction limit discrimination unit, the determination unit causes the write processing unit to continue the write processing for the second data track, and
when determining that the error correction of the data on the first data track, which is performed by the error correction unit, has exceeded a limit, based on the information, the determination unit causes the write processing unit to terminate the write processing for the second data track.

8. The magnetic disk device of claim 7, wherein
each time the data is written to each of the target sectors of the second data track, the correction limit discrimination unit measures an actual excess amount at which the position of the write head crosses the variable reference line in the first direction, and updates a cumulative actual excess amount, which is a cumulative total of the actual excess amount,
the information obtained by the correction limit discrimination unit is the cumulative actual excess amount, and
during the second write period,
when determining that the cumulative actual excess amount is smaller than or equal to an upper limit threshold value, the determination unit causes the write processing unit to continue the write processing for the second data track,
the upper limit threshold value is a value indicating a limit of a range in which the error correction for the first data track is capable of being performed, and
when determining that the cumulative actual excess amount has exceeded the upper limit threshold value, the determination unit causes the write processing unit to terminate the write processing for the second data track.

9. The magnetic disk device of claim 8, wherein
the correction limit discrimination unit counts the number of the one or more corrupted target sectors on the first data track and updates the cumulative number that is the cumulative count,
the information obtained by the correction limit discrimination unit further includes the cumulative number,
during the second write period,
when determining that the cumulative actual excess amount is smaller than or equal to the upper limit threshold value and determining that the cumulative number is smaller than or equal to the upper limit number, the determination unit causes the write processing unit to continue the write processing for the second data track,
the upper limit number is the number indicating a limit of the range in which the error correction for the first data track is capable of being performed, and
when determining that the cumulative number has exceeded the upper limit number, the determination unit causes the write processing unit to terminate the write processing for the second data track.

10. The magnetic disk device of claim 7, wherein
during the second write period, when the determination unit causes the write processing unit to terminate the write processing for the second track, the determination unit causes the write processing unit to save the remaining data that has not been written to the second data track to a recording area other than the first data track and the second data track.

11. The magnetic disk device of claim 1, wherein
the write processing unit is capable of selecting shingled magnetic recording of overwriting data of the second data track on the data of the first data track in an overwrite direction that is the second direction.

12. A write processing method applicable to a magnetic disk device including:
a disk having a first data track and a second data track adjacent to each other in a recording layer, the first data track and the second data track each including a plurality of target sectors being targets to which data is written, the first data track being located in a first direction parallel to a radial direction of the disk as viewed from the second data track;
a head including a write head writing data to the recording layer and a read head reading data from the recording layer;
a read processing unit capable of deriving position information of the write head in the radial direction by seeking the read head; and
a write processing unit capable of performing write processing of writing data to the recording layer, the write processing unit setting a target position of the write head in the radial direction to a first write target line extending in a circumferential direction of the disk during a first write period for writing data to the first data track, and setting the target position of the write head in the radial direction to a second write target line extending in the circumferential direction during a second write period for writing data to the second data track,
the method comprising:
determining whether the write head has crossed each of a fixed reference line and a fixed additional line in a second direction opposite to the first direction, during the first write period;
controlling the write processing for the first data track, based on information indicating whether the write head has crossed the fixed reference line in the second direction, during the first write period; and
controlling the write processing for the second data track, based on information indicating whether the write head has crossed the fixed additional line in the second direction, during the first write period.

13. The write processing method of claim 12, wherein
the fixed reference line extends in the circumferential direction and is located at a position shifted in the second direction from the first write target line, and
the fixed additional line extends in the circumferential direction, and is located at a position shifted in the second direction from the first write target line and a position shifted in the first direction from the fixed reference line.

14. The write processing method of claim 13, wherein
during the first write period,
when it is determined that the write head has not crossed the fixed additional line in a second direction opposite to the first direction, the write processing for the first data track is continued in the write processing unit, and the first base line is generated by shifting the initial line in the first section where the write head has not crossed the fixed additional line in the second direction in the circumferential direction, in a direction parallel to the radial direction by an amount corresponding to the first variation amount of the position of the write head in the radial direction, and the variable reference line in the first section is updated from the initial line to the first base line,
when it is determined that the write head has crossed the fixed additional line in the second direction that the write head has not crossed the fixed reference line in the second direction, the write processing unit continues the write processing for the first data track, and the second base line is generated by shifting the initial line in a second section where the write head has crossed the fixed additional line in the second direction and has not crossed the fixed reference line in the second direction, in the circumferential direction, by an amount corresponding to a second variation amount of the position of the write head in the radial direction, and a strict line is generated by shifting the second base line in the second section by an amount corresponding to an excessive amount at which the write head has crossed the fixed additional line in the second direction, and the variable reference line in the second section is updated from the initial line to the strict line,
when it is determined that the write head has crossed the fixed additional line in the second direction and further crossed the fixed reference line in the second direction, an operation of the write processing unit is controlled, and the variable reference line in a third section where the write head has crossed the fixed reference line in the second direction in the circumferential direction, is maintained as the initial line,
during the second write period following the first write period,
when it is determined that the write head has not crossed the variable reference line in the first direction, the write processing unit continues the write processing for the second data track,
when it is determined that the write head has crossed the variable reference line in the first direction, an operation of the write processing unit is controlled, and
the initial line extends in the circumferential direction and is located at a position shifted in the first direction from the second write target line.

15. The write processing method of claim 14, wherein
during the first write period,
when it is determined that the write head has crossed the fixed reference line in the second direction, the write processing for the first data track by the write processing unit is suspended, and
the target sector serving as a starting point for suspending the write processing, among the plurality of target sectors of the first data track, is a target sector which the write head faces immediately after detecting that the write head has first crossed the fixed additional line in the second direction.

16. The write processing method of claim 15, wherein
after suspending the write processing for the first data track by the write processing unit, during the first write period,
the write processing unit is caused to maintain the target position of the write head to the first write target line,
waiting for the disk to rotate is performed, and
write retry processing of resuming write processing for the first data track by the write processing unit is performed from the target sector which is the starting point.

17. The write processing method of claim 14, applicable to the magnetic disk device further comprising an error correction unit executing error correction of data in one or more corrupted target sectors whose data is determined to be corrupted, among the plurality of target sectors of the first data track, wherein
during the second write period,
each time data is written to each of the target sectors of the second data track, information that the position of the write head crosses the variable reference line in the first direction is obtained,
when it is determined that the error correction of the data on the first data track, which is performed by the error correction unit, does not exceed a limit, based on the information, the write processing for the second data track by the write processing unit is continued, and
when it is determined that the error correction of the data on the first data track, which is performed by the error correction unit, has exceeded a limit, based on the information, the write processing for the second data track by the write processing unit is terminated.

18. The write processing method of claim 17, wherein
during the second write period, when the write processing for the second track by the write processing unit is terminated, remaining data that has not been written to the second data track is saved to a recording area other than the first data track and the second data track by the write processing unit.

19. The write processing method of claim 12, wherein
the write processing unit is capable of selecting shingled magnetic recording of overwriting data of the second data track on the data of the first data track in an overwrite direction that is the second direction.
